(19) United States
(12) Patent Application Publication
(10) Pub. No.: US 2026/0371005 A1
(43) Pub. Date: Nov. 19, 2026

(54) DISPLAY DEVICE

(71) Applicant: HISENSE VISUAL TECHNOLOGY CO., LTD., Qingdao (CN)

(72) Inventors: An WANG, Qingdao (CN); Guanglin ZUO, Qingdao (CN)

(21) Appl. No.: 19/730,142

(22) Filed: Jul. 2, 2026

Related U.S. Application Data
(63) Continuation of application No. PCT/CN2025/098962, filed on Jun. 4, 2025.

(30) Foreign Application Priority Data
Jun. 4, 2024 (CN) 202410718300.7
Jun. 4, 2024 (CN) 202410718447.6
Jun. 4, 2024 (CN) 202410718456.5
Jun. 4, 2024 (CN) 202421264337.9
Jun. 4, 2024 (CN) 202421264950.0
Jun. 4, 2024 (CN) 202421264963.8

(51) Int. Cl. H04R 1/34; H04R 1/02; H04R 1/24

(52) U.S. Cl. CPC H04R 1/345; H04R 1/028; H04R 1/24; H04R 2499/15

(57) ABSTRACT

A display apparatus includes a display module, a rear housing, a side frame, a first speaker, and a first sound guide member. The first speaker includes a first loudspeaker and a speaker housing. The first sound guide member is arranged between the speaker housing and the rear housing and in contact with the speaker housing and the rear housing respectively. The first sound guide member, the speaker housing, and the rear housing together enclose a first sound cavity. The first loudspeaker is located within the first sound cavity. The first sound guide member forms at least part of a first sound outlet. The first sound outlet is in communication with the first sound cavity. The first sound cavity, the first sound outlet, and the sound holes form a sound output channel. The first sound guide member is elastic and elastically connects the speaker housing and the rear housing.

### CROSS-REFERENCE TO RELATED APPLICATIONS

This application is a continuation application of International Application No. PCT/CN2025/098962, filed on Jun. 4, 2025, which claims priorities to Chinese Patent Application No. 202410718447.6, filed on Jun. 4, 2024; Chinese Patent Application No. 202421264963.8, filed on Jun. 4, 2024; Chinese Patent Application No. 202410718456.5, filed on Jun. 4, 2024; Chinese Patent Application No. 202421264337.9, filed on Jun. 4, 2024; Chinese Patent Application No. 202421264950.0, filed on Jun. 4, 2024; and Chinese Patent Application No. 202410718300.7, filed on Jun. 4, 2024, all of which are hereby incorporated by reference in their entireties.

### TECHNICAL FIELD

Embodiments of the present disclosure relate to the technical field of display, and particularly to a display apparatus.

### BACKGROUND

With the development of the technical field of display apparatuses, users have increasingly higher requirements for visual and auditory effects of the display apparatuses. The thickness of a display apparatus, such as a television, is becoming thinner and thinner. The increasingly thinner display apparatus results in limited internal space, which reduces the space available for speaker(s), making it difficult for the display apparatus to achieve desirable sound quality.

### SUMMARY

Some embodiments of the present disclosure provide a display apparatus. The display apparatus includes: a display module, having a display side and a back side opposite to the display side along a thickness direction of the display apparatus. The display side of the display module faces a front side of the display apparatus. The display module includes: a display panel, configured to display image information; a backlight assembly, configured to provide backlight for the display panel; and a back plate, configured to provide an installation position for the backlight assembly. The display apparatus further includes a rear housing, being an exterior component of the display apparatus and located on the back side of the display module. The back plate is located between the backlight assembly and the rear housing. A side frame is connected between an edge of the rear housing and an edge of the display module, the side frame being provided with sound holes. A first speaker is mounted on the back plate and located between the display module and the rear housing. The first speaker includes a speaker housing; a first loudspeaker; and a first sound guide member. A sound output direction of the first speaker faces the rear housing, and a diaphragm of the first loudspeaker is spaced apart from the rear housing. The speaker housing provides an installation position for the first loudspeaker. The first sound guide member is located between the speaker housing and the rear housing, and in contact with the speaker housing and the rear housing respectively. The first sound guide member, the speaker housing, and the rear housing together enclose a first sound cavity, and the first loudspeaker is located within the first sound cavity. The first sound guide member forms at least part of a first sound outlet, the first sound outlet is in communication with the first sound cavity, and the first sound cavity, the first sound outlet, and the sound holes form a sound output channel. The first sound guide member is elastic to elastically connect the speaker housing and the rear housing. The first sound guide member is configured to guide sound waves facing the rear housing to a lateral side, at least a part of sound waves from the first speaker are emitted through the first sound outlet under confinement of the first sound guide member and the rear housing, to provide lateral sound emission of the first speaker. The first speaker has a front side and a rear side along the thickness direction of the display apparatus, and the first sound outlet is provided on a side of the first speaker other than the front side and the rear side of the first speaker.

### BRIEF DESCRIPTION OF THE DRAWINGS

FIG. 1 is a schematic cross-sectional view of a speaker in a display apparatus;

FIG. 2A is a schematic cross-sectional view of a display apparatus according to some embodiments;

FIG. 2B is an exploded view of a display apparatus according to some embodiments;

FIG. 3 is an exploded view of a speaker according to some embodiments;

FIG. 4 is a rear view of a speaker according to some embodiments;

FIG. 5 is a partial cross-sectional view of a speaker and a rear housing according to some embodiments;

FIG. 6 is a schematic structural view of a first sound guide member according to some embodiments;

FIG. 7 is a schematic partial connection view of a first sound guide member according to some embodiments;

FIG. 8 is a schematic connection view of a first sound guide member and a speaker housing according to some embodiments;

FIG. 9 is a schematic connection view of a first sound guide member and a speaker housing according to some embodiments;

FIG. 10 is a schematic cross-sectional view of a first sound guide member according to some embodiments;

FIG. 11 is a schematic cross-sectional view of a first sound guide member according to some embodiments;

FIG. 12 is a front view of a first sound guide member according to some embodiments;

FIG. 13 is a rear view of a first speaker according to some embodiments;

FIG. 14 is a rear view of a display apparatus with a rear housing removed according to some embodiments;

FIG. 15 is a schematic structural view of a first speaker of a display apparatus according to some embodiments;

FIG. 16 is an exploded view of a first speaker of a display apparatus according to some embodiments;

FIG. 17 is a schematic cross-sectional view of a display apparatus according to some embodiments;

FIG. 18 is a schematic cross-sectional view of a display apparatus according to some embodiments;

FIG. 19 is a schematic layout view of sound outlet holes according to some embodiments;

FIG. 20 is a schematic layout view of sound outlet holes according to some embodiments;

FIG. 21 is a partial schematic view of a damping component and a rear housing according to some embodiments;

FIG. 22 is a partial schematic view of a damping component and a rear housing according to some embodiments;

FIG. 23 is a schematic cross-sectional view of a damping component installed in a sound outlet hole according to some embodiments;

FIG. 24 is a schematic structural view of a damping component according to some embodiments;

FIG. 25 is an exploded view of a bass speaker according to some embodiments;

FIG. 26 is a front view of a rear housing and a bass speaker according to some embodiments;

FIG. 27 is a cross-sectional view taken along line A-A in FIG. 26;

FIG. 28 is an enlarged view of a region P in FIG. 27;

FIG. 29 is a schematic view of positions of a rear housing and speakers according to some embodiments;

FIG. 30 is a schematic view of positions of a rear housing and speakers according to some embodiments; and

FIG. 31 is a schematic view of positions of a rear housing and speakers according to some embodiments.

### DETAILED DESCRIPTION

Embodiments of the present disclosure will be described clearly and completely below with reference to accompanying drawings. Apparently, embodiments described are only some embodiments of the present disclosure, rather than all of the embodiments. Based on embodiments according to the present disclosure, all other embodiments obtained by a person of ordinary skill in the art fall within the scope of protection of the present disclosure.

Unless the context otherwise requires, throughout the specification and the claims, the term “comprise” and its other forms such as the third-person singular form “comprises” and the present participle form “comprising” are to be interpreted as open and inclusive, i.e., “including, but not limited to”. In the description of the specification, the terms “one embodiment”, “some embodiments”, “exemplary embodiments”, “example”, “specific example”, or “some examples” are intended to indicate that a particular feature, structure, material, or characteristic associated with that embodiment or example is included in at least one embodiment or example of the present disclosure. The schematic representations of the above terms do not necessarily refer to the same embodiment or example. Furthermore, the particular feature, structure, material, or characteristic may be included in any suitable manner in any one or more embodiments or examples.

Hereinafter, the terms “first” and “second” are used for descriptive purposes only and are not to be construed as indicating or implying relative importance or implicitly indicating the number of the indicated technical features. Thus, a feature defined with “first” or “second” may explicitly or implicitly include one or more of the feature. In the description of the embodiments of the present disclosure, unless otherwise specified, “a plurality of” means two or more.

With the development of the technical field of display apparatus, users have increasingly higher requirements for visual and auditory effects of the display apparatus such as a television. Visually, thinning of the display apparatus such as the television is an industry trend. Auditorily, the display apparatus generally uses built-in speakers to output sound signals.

However, as the display apparatus becomes thinner, the installation space for speakers in the display apparatus gradually decreases, and the sound quality of the display apparatus becomes increasingly worse, thus failing to meet user requirements.

In the existing technology, the speaker used in the display apparatus generally outputs sound through physical vibration. An output volume relies on a diaphragm or vibrating body of the speaker itself. A vibration gap is required between the diaphragm and internal components of the display apparatus, and the volume of the diaphragm affects the intensity of the output volume. Therefore, the volume of the conventional speaker cannot be reduced, and the speaker must occupy the internal space of the display apparatus, which is detrimental to the thinning of display apparatus.

Moreover, due to the limited internal space of display apparatus, the volume of the speaker cannot be arbitrarily increased, thus limiting the intensity of the sound field output by the speaker inside the display apparatus. In the display apparatus such as the television, a plurality of different sets of speakers are generally provided at different positions to create different sound field patterns, which increases the number of speakers required in the display apparatus, exacerbating the problem of speakers occupying the internal space of the display apparatus.

For the above reasons, speakers used in display apparatus in the existing technology have disadvantages of occupying space and insufficient output sound field intensity. Therefore, how to solve the foregoing problems through structural improvements has become one of the important issues for satisfying the dual requirements of hearing and vision for display apparatus.

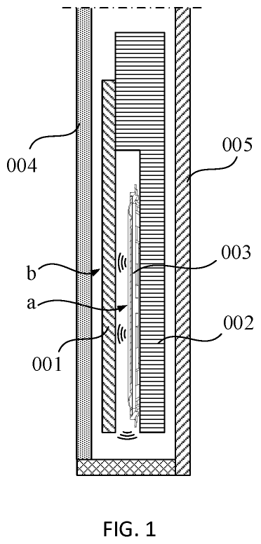

The sound-producing structure within a display apparatus is a speaker. As shown in FIG. 1, which is a schematic cross-sectional view of a speaker in a display apparatus in existing technology, the speaker is mounted on a side of a rear housing 004 of the display apparatus facing a display module 005.

The speaker includes a speaker housing 002, a sound guide baffle 001, and a loudspeaker 003. The speaker housing 002 is close to the display module 005, and the sound guide baffle 001 is close to the rear housing 004. Both the speaker housing 002 and the sound guide baffle 001 are rigid components, and the speaker housing 002 and the sound guide baffle 001 together enclose an accommodating cavity. The loudspeaker 003 is located within the accommodating cavity and is mounted on the speaker housing 002. Since a diaphragm of the loudspeaker 003 vibrates toward the rear housing 004, the sound guide baffle 001 guides sound waves of the loudspeaker 003, for example, guiding the sound waves to a side surface of the display apparatus.

There is a gap a between the sound guide baffle 001 and the diaphragm of the loudspeaker 003, and there is also a gap b between the sound guide baffle 001 and the rear housing 004. Moreover, the sound guide baffle 001 itself has a thickness, which results in a relatively large overall thickness of the speaker.

Since the display apparatus according to the existing technology has a narrow bezel, there is insufficient space to arrange the speaker. Therefore, the speaker must be disposed on the back side of the display module. The diaphragm of the loudspeaker has a relatively large diameter, and a plane of a diameter of the diaphragm of the loudspeaker is parallel to a display surface of the display apparatus. Accordingly, the diaphragm requires a certain vibration gap, so the gap a cannot be omitted. Since the loudspeaker emits sound backward, a guide member (e.g., the sound guide baffle 001) for guiding sound waves is inevitably required, i.e., the guide member cannot be omitted. To avoid contact between the guide member and other components (e.g., the rear housing) of the display apparatus that would generate noise, a gap is also required between the guide member and the other components, i.e., the gap b cannot be omitted. Thus, the speaker needs to provide a cavity for accommodating the loudspeaker, and also provide a vibration gap and installation space for the guide member, making it impossible to reduce the thickness of the speaker.

Inventors of the present disclosure have conducted detailed research on the components for achieving vibration and sound production in the speaker structure, and re-analyzed the necessity of each component for realizing the functions of the speaker. For the speaker structure, the loudspeaker, as a sound-producing element, is indispensable. An installation position for the loudspeaker is required. It is necessary to form a sound cavity and a side sound outlet, and to provide a vibration gap for the loudspeaker.

Through analysis, the inventors of the present disclosure consider that the sound guide baffle 001 in FIG. 1 can be omitted, and omitting the sound guide baffle 001 can eliminate the thickness of the sound guide baffle itself and the gap b, which greatly contributes to reducing the thickness of the speaker.

The inventors of the present disclosure have continued further research on the display apparatus and a speaker structure of the display apparatus in the existing technology. As an exterior component, the rear housing of the display apparatus serves to shield the internal structure of the display apparatus, and a structural stability of the rear housing is crucial. Therefore, a gap is generally provided between the rear housing and the speaker, which not only prevents the sound wave vibration of the speaker from affecting the structural stability of the entire machine, but also reduces the possibility of noise generated by vibration of the rear housing.

The inventors of the present disclosure have continued to analyze the speaker structure in the existing technology. As shown in FIG. 1, the sound guide baffle 001 is opposite to and spaced apart from the rear housing 004. At least a portion of the rear housing 004 is plate-shaped, similar in structure to the sound guide baffle 001. Therefore, the inventors of the present disclosure consider that the rear housing 004 can be used to replace the sound guide baffle 001 to guide the sound waves so that the speaker emits sound laterally. However, this brings a new problem: the rear housing bears the vibration of the sound waves. How can the possibility of noise be reduced and the acoustic effect be ensured?

The inventors of the present disclosure have experimented by directly connecting the speaker housing to the rear housing, and found that the rear housing vibrated significantly, which not only affected the structural stability of the entire machine but also resulted in poor acoustic effect of the display apparatus. This is because both the speaker housing and the rear housing are rigid components, and under the action of vibration, the hard contact between the speaker housing and the rear housing generates noise. Moreover, the speaker housing, as a mounting component for the loudspeaker, and the rear housing, as an exterior component, both need to have rigid characteristics.

Therefore, the inventors of the present disclosure have considered elastically connecting the speaker housing and the rear housing via an elastic component. Considering the sealing of the accommodating cavity at positions other than the sound outlet, and reducing the possibility of sound leakage at positions other than the sound outlet, the inventors of the present disclosure have arranged an elastic sound guide member between the speaker housing and the rear housing, using the rear housing, the sound guide member, and the speaker housing to enclose a sound cavity having a sound outlet. The sound guide member seals the space between the speaker housing and the rear housing at positions other than the sound outlet, reducing the possibility of sound leakage from the sound cavity, and allowing sound waves to be concentrated and emitted from the sound outlet as much as possible, which is conducive to improving the acoustic effect. When sound waves are transmitted to the rear housing, because the sound guide member is elastic, the sound guide member elastically deforms to absorb part of energy of the sound wave on the rear housing, reducing the vibration force on the rear housing and ensuring the stability of the connection structure of the rear housing, which is conducive to reducing the possibility of noise generated by vibration of the rear housing and ensuring the acoustic effect. Moreover, when sound waves are transmitted to the sound guide member, the sound guide member can not only guide the sound waves to the sound outlet, but also absorb part of energy of the sound wave, reduce reflection of the sound wave, and make the sound response smoother across various frequency bands, resulting in better sound quality.

Since the sound guide baffle is omitted, the thickness of the sound guide baffle and the gap between the sound guide baffle and the rear housing are saved, reducing the thickness of the speaker. In view of this, in the display apparatus of the present disclosure, the speaker not only has a small thickness, which is beneficial to the slim design of the display apparatus, but also can achieve good sound quality.

Technical schemes in some embodiments of the present disclosure will be described clearly and completely below with reference to the accompanying drawings in some embodiments of the present disclosure. Apparently, the described embodiments are only some of the embodiments of the present disclosure, rather than all of the embodiments. Based on the embodiments in the present disclosure, all other embodiments obtained by a person of ordinary skill in the art without making creative efforts fall within the scope of protection of the present disclosure.

The display apparatus according to embodiments of the present disclosure may have various implementation forms, for example, may be a television, a smart television, a monitor, an electronic bulletin board, an electronic table, or the like.

Some embodiments of the present disclosure provide a display apparatus 10. The display apparatus 10 may be a liquid crystal display apparatus, an OLED display apparatus, a laser display apparatus, or the like. The display apparatus 10 has a top side, a bottom side, a left side, a right side, a front side, and a rear side. The left side and the right side of the display apparatus 10 refer to the left side and the right side of a user when the user faces a display surface of the display apparatus 10. Correspondingly, the side of the display apparatus 10 facing the user is the front side, the side of the display apparatus 10 facing away from the user is the rear side, the upper side of the display apparatus 10 is the top side, and the lower side of the display apparatus 10 is the bottom side.

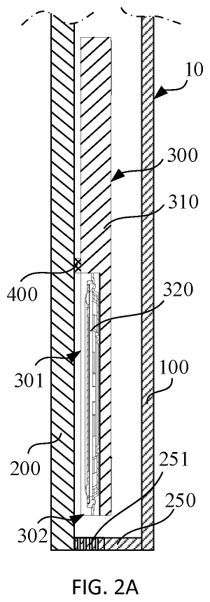

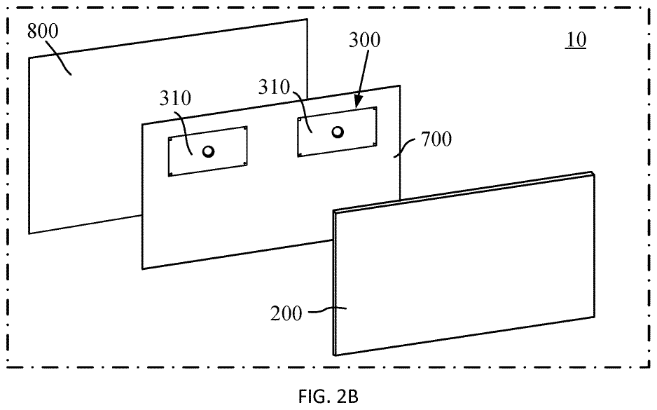

Referring to FIG. 2A, a display apparatus 10 according to some embodiments of the present disclosure includes a display module 100. The display module 100 is configured to display image information such as text and images. The display module 100 has a display side and a back side opposite to each other in a thickness direction of the display apparatus. The display side of the display module 100 faces the front side of the display apparatus.

In some embodiments, the display module 100 includes a display panel configured to display image information such as text and images. Exemplarily, the display panel may be a liquid crystal display panel.

In some embodiments, the display module 100 further includes a backlight assembly. The backlight assembly is located on one side of the display panel and is configured to provide backlight to the display panel, so that the display panel can modulate the backlight as needed to display different images.

In some embodiments, the display apparatus 10 includes a rear housing 200. The rear housing 200 is located on the back side of the display module 100. The rear housing 200 may be an appearance housing of the display apparatus 10, and a material of the rear housing 200 may be plastic, metal, or the like.

In some embodiments, the display apparatus 10 includes a first speaker 300. The first speaker 300 is a sound-producing component of the display apparatus 10 and is disposed between the rear housing 200 and the display module 100.

With continued reference to FIG. 2A, in some embodiments, the first speaker 300 includes a first loudspeaker 320. The first loudspeaker 320 is a sound-producing element of the first speaker 300.

In some embodiments, the first loudspeaker 320 is a midrange loudspeaker. Exemplarily, a sound wave frequency range of the first loudspeaker 320 is 200 Hz to 8 KHz, or the sound wave frequency range of the first loudspeaker 320 is 200 Hz to 10 KHz.

In some embodiments, the first loudspeaker 320 is a full-range loudspeaker or a mid-high frequency loudspeaker. Exemplarily, the sound wave frequency range of the first loudspeaker 320 is 200 Hz to 20 KHz.

Exemplarily, the first loudspeaker 320 may include a diaphragm, a magnetic assembly, a bracket, a basket, a voice coil, or the like. The bracket is used to mount the diaphragm, the magnetic assembly, the basket, the voice coil, etc. The diaphragm vibrates under cooperation of the magnetic assembly and the voice coil to produce sound.

In some embodiments, the first speaker 300 includes a speaker housing 310. The speaker housing 310 is an outer casing of the first speaker 300 and provides an installation position for the first loudspeaker 320.

In some embodiments, the speaker housing 310 may be an injection-molded shell. For example, the speaker housing 310 is a plastic shell formed by injection molding, which is simple to manufacture. In some embodiments, the speaker housing 310 may be a metal shell, which has high structural strength. With the same structural strength, the metal speaker housing 310 can be thinner, which is beneficial to reducing the thickness of the first speaker 300. Moreover, the metal speaker housing 310 can contact the magnetic assembly of the first loudspeaker 320, which is beneficial to increasing the heat dissipation area of the first loudspeaker 320, improving the heat dissipation effect of the first loudspeaker 320.

The speaker housing 310 may be mounted on the rear housing 200, providing ample installation space and flexible connection methods.

Referring to FIG. 2B, the speaker housing 310 may be mounted on a back plate 700 of the display apparatus 10. The back plate 700 of the display apparatus 10 is located between the backlight assembly 800 and the rear housing 200, and the back plate 700 may provide an installation position for the backlight assembly 800. With such an arrangement, the speaker housing 310 can be mounted on the back plate 700, and the rear housing 200 can be assembled, which simplifies the assembly of the display apparatus 10, and facilitates electrical connection between the first speaker 300 and a main control board of the display apparatus 10. Moreover, when the rear housing 200 is removed, the first speaker 300 does not need to be removed, allowing the disassembly to be simple and convenient.

In some embodiments, the speaker housing 310 is elastically connected to the back plate 700. The sound wave vibration force on the speaker housing 310 is converted into an elastic force between the speaker housing 310 and the back plate 700, which can avoid noises caused by rigid contact between the speaker housing 310 and the back plate 700, and can reduce vibration noises between the speaker housing 310 and the back plate 700, providing improved acoustic effect of the display apparatus 10.

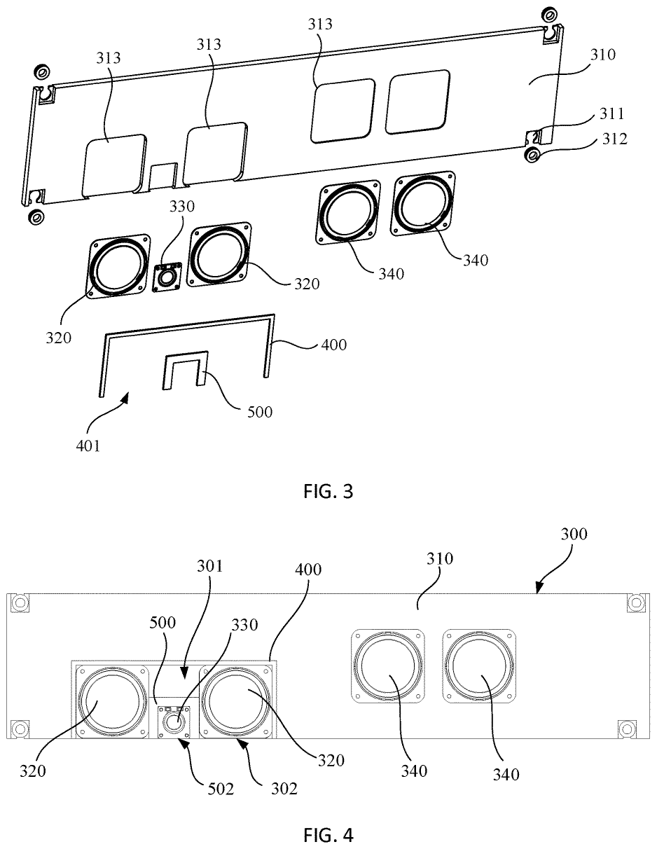

Exemplarily, with reference to FIG. 3, the speaker housing 310 is provided with fixing holes 311. Fasteners such as screws and bolts pass through the fixing holes 311 and are threadedly connected to threaded holes provided on the back plate. An elastic washer is disposed between the fastener and the speaker housing 310, and an elastic washer is disposed between the speaker housing 310 and the back plate, achieving elastic connection between the speaker housing 310 and the back plate.

Exemplarily, with reference to FIG. 3, the speaker housing 310 is provided with fixing holes 311. An elastic ring 312 is disposed in the fixing hole 311. An annular groove is provided on a peripheral side surface of the elastic ring 312, so that the elastic ring 312 is sleeved on an edge of the fixing hole 311. The elastic ring 312 is provided with a through hole to allow a fastener to pass through the through hole and be fixedly connected to the rear housing 200. In this way, not only can the speaker housing 310 and the back plate be elastically connected in an axial direction of the fixing hole 311, but also the speaker housing 310 and the fastener can be elastically connected in the axial direction of the fixing hole 311, avoiding rigid contact between the speaker housing 310 and the back plate and also avoiding rigid contact between the speaker housing 310 and the fastener.

Referring back to FIG. 1, the speaker housing 002 is mounted on the rear housing 004. Due to the presence of the sound guide baffle 001, the gap between the speaker housing 002 and the sound guide baffle 001 is relatively large, and a height of a cylinder with threaded holes formed on the rear housing 004 is relatively large, which not only uses more material but also makes molding difficult and demolding challenging when the rear housing 004 is formed by injection molding.

Compared with the existing technology, in some embodiments of the present disclosure, the gap between the speaker housing 310 and the rear housing 200 is relatively small, which is beneficial to reducing the difficulty of connecting the fastener to the threaded hole and improving assembly efficiency. Moreover, a height of a cylinder with threaded holes formed on the rear housing 200 is relatively small, reducing material usage and also improving structural stability. When the rear housing 200 is an injection-molded part, it is beneficial to reducing the difficulty of molding.

In some embodiments, the speaker housing 310 is provided with a plurality of fixing holes 311 to improve the stability and reliability of mounting the speaker housing 310. The plurality of fixing holes 311 are located at edges of the speaker housing 310, so as not to interfere with the arrangement of the loudspeaker.

Exemplarily, when the speaker housing 310 has a rectangular shape, fixing holes 311 are respectively provided at four corners of the speaker housing 310. This ensures the mounting stability of the speaker housing 310 while leaving a large amount of space in the middle of the speaker housing 310 for flexible arrangement of the loudspeaker.

Exemplarily, a plurality of fixing holes 311 are provided at a side edge of the speaker housing 310. The fixing holes 311 may also be located within a first sound cavity 301, as long as the fixing holes 311 do not affect mounting of the first loudspeaker 320 or conduction of sound waves.

The first loudspeaker 320 may be mounted on the speaker housing 310 in various ways. For example, a basket of the first loudspeaker 320 is fixed to the speaker housing 310 by screws, which provides a stable and reliable fixing manner. As another example, the basket of the first loudspeaker 320 is clamped or adhered to the speaker housing 310, which provides a simple fixing manner.

In some embodiments, the first loudspeaker 320 is mounted on a side of the speaker housing 310 facing the rear housing 200, so that the first loudspeaker 320 is directly opposite the rear housing 200.

Since the diaphragm needs to reciprocate to produce sound, a vibration space needs to be reserved for the diaphragm of the first loudspeaker 320. In some embodiments of the present disclosure, a gap is provided between the diaphragm of the first loudspeaker 320 and the rear housing 200, so that the diaphragm reciprocates within the gap to produce sound.

The diaphragm of the first loudspeaker 320 faces the rear housing 200 of the display apparatus 10, causing the first loudspeaker 320 to emit sound toward the rear side of the display apparatus 10, which may result in poor acoustic effect of the display apparatus 10 and affect the auditory experience.

In view of this, in some embodiments, the display apparatus 10 includes a first sound guide member 400. The first sound guide member 400 is configured to guide rearward sound waves to a lateral side, so that the sound waves are emitted from a lateral side of the display apparatus 10, for example, the top side, the bottom side, the left side, or the right side of the display apparatus 10, improving the acoustic effect of the display apparatus 10.

The first sound guide member 400 is located between the speaker housing 310 and the rear housing 200. The first sound guide member 400 is in contact with both the speaker housing 310 and the rear housing 200. The first sound guide member 400, the speaker housing 310, and the rear housing 200 together enclose a first sound cavity 301, providing an installation space for the first loudspeaker 320.

In some embodiments, with reference to FIGS. 2 and 3, the speaker housing 310 is formed with mounting grooves 313. The mounting groove 313 has a first opening facing the rear housing 200. The first loudspeaker 320 is mounted within the mounting groove 313, so that the thickness of the first loudspeaker 320 occupies the thickness space of the speaker housing 310, which is beneficial to reducing the thickness of the first speaker 300.

Exemplarily, the speaker housing 310 is plate-shaped, and the mounting groove 313 for accommodating the first loudspeaker 320 is formed in the plate-shaped structure. Such an arrangement simplifies the structural configuration of the speaker housing 310 and makes it easy to process and install.

In some embodiments, the rear housing 200 is formed with an accommodating groove to reserve an installation space for the first loudspeaker 320. When the speaker housing 310 is integrally formed, the accommodating groove is formed without requiring an additional process. The speaker housing 310 is plate-shaped, making the structure even simpler.

In some embodiments, the speaker housing 310 is plate-shaped, and a partial region of the rear housing 200 opposite the speaker housing 310 is also plate-shaped. The space between the speaker housing 310 and the rear housing 200, isolated by the first sound guide member 400, forms the installation space for the first loudspeaker 320.

The first loudspeaker 320 is located within the first sound cavity 301. The first sound guide member 400 forms at least part of a first sound outlet 302. The first sound outlet 302 is in communication with the first sound cavity 301. In this way, at least part of the sound waves from the first loudspeaker 320 are emitted through the first sound outlet 302 under the confinement of the first sound guide member 400 and the rear housing 200, achieving lateral sound emission of the first speaker 300.

Lateral sound emission of the first speaker 300 can be understood as the first speaker 300 having a front side and a rear side along the thickness direction of the display apparatus, with the first sound outlet 302 being provided on a side of the first speaker 300 other than the front side and the rear side, for example, a bottom side.

Thus, in the display apparatus according to the embodiments of the present disclosure, the first speaker 300 eliminates the sound guide baffle present in conventional speakers. The speaker housing 310, the first sound guide member 400, and the rear housing 200 together enclose the first sound cavity 301 that accommodates the first loudspeaker 320. The diaphragm of the first loudspeaker 320 emits sound toward the rear housing 200. The first sound cavity 301 guides the sound waves to the first sound outlet 302, allowing the sound waves to be emitted and ensuring the sound effect of the first speaker 300. Since the sound guide baffle is eliminated, the thickness of the sound guide baffle and the gap between the sound guide baffle and the rear housing are saved, reducing the thickness of the speaker.

Referring to FIG. 4, the first sound guide member 400 is located outside the first loudspeaker 320, so that the first loudspeaker 320 is located within the first sound cavity 301.

In some embodiments, the first sound guide member 400 may only surround the outside of the diaphragm of the first loudspeaker 320. In this case, the first sound guide member 400 may contact the basket of the first loudspeaker 320.

In some embodiments, the first sound guide member 400 is disposed within the mounting groove 313. With such an arrangement, a first sound guide member 400 with a larger thickness can be provided, which provides more sufficient elastic force. A mounting groove 313 with a larger area can be provided, allowing flexible configuration of the number, positions, and spacing of the first loudspeakers 320 according to performance requirements of the display apparatus.

In other embodiments, the first sound guide member 400 is located outside the mounting groove 313. Such an arrangement allows the mounting groove 313 to have a smaller area, ensuring the structural strength of the speaker housing 310 and reducing the possibility of deformation. Moreover, with the first sound guide member 400 located outside the mounting groove 313, installation is facilitated, and the possibility of damaging the first loudspeaker 320 due to installation of the first sound guide member 400 is reduced.

In some embodiments, the first sound guide member 400 alone forms the first sound outlet 302 by providing a notch or a break, resulting in a simple structure. In other embodiments, the first sound guide member 400 and the speaker housing 310 together define the first sound outlet 302, which is beneficial to increasing a sound outlet area of the first sound outlet 302.

With continued reference to FIGS. 3 and 4, in some embodiments, the first sound guide member 400 is formed with a break 401, and the first sound guide member 400 is an open ring shape, so that the first sound guide member 400 semi-surrounds the outside of the first loudspeaker 320. The break 401 forms at least part of the first sound outlet 302. With such an arrangement, the first sound guide member 400 can be formed by splicing a plurality of segments of strip-shaped sound guide strips, simultaneously forming the break 401. This not only simplifies the formation structure of the first sound guide member 400, eliminating the need for an additional mold to process the first sound guide member 400, but also improves the flexibility in dimension and shape of the first sound guide member 400, allowing the formation of sound cavities of different dimensions and shapes.

In some embodiments, a length of the break 401 formed by the first sound guide member 400 is equal to a diameter of the diaphragm of the first loudspeaker 320. Such an arrangement allows the sound waves of the first loudspeaker 320 to be emitted through the break 401, while also preventing the break 401 from being too small so that portions of the first sound guide member 400 on both sides of the break 401 block the diaphragm and affect the sound output effect.

In some embodiments, the length of the break 401 formed by the first sound guide member 400 may have a certain deviation from the diameter of the diaphragm of the first loudspeaker 320. For example, if the length of the break 401 is slightly larger than the diameter of the diaphragm, not only emission of sound waves cannot be blocked, but also the break 401 can be avoided to be too large which leads to sound wave dispersion and affecting the structural strength of the first sound guide member 400. As another example, if the length of the break 401 is slightly smaller than the diameter of the diaphragm, the blocking effect of the break 401 on the sound waves is negligible, ensuring the structural strength and supporting function of the first sound guide member 400.

In some embodiments, the mounting groove 313 extends to a side edge of the speaker housing 310, for example, a bottom edge, so that the mounting groove 313 forms a second opening facing a side surface of the speaker housing 310. The side surface of the speaker housing 310 here refers to a surface other than the front side surface and the rear side surface of the speaker housing 310. Such an arrangement allows the first loudspeaker 320 to be close to the edge of the speaker housing 310, facilitating lateral sound emission.

In some embodiments, the second opening of the mounting groove 313 is at least partially opposite the break 401 of the first sound guide member 400. With such an arrangement, the second opening and the break 401 together form the first sound outlet 302, which can increase the sound outlet area of the first sound outlet 302 and improve the sound output effect. Moreover, the first sound outlet 302 has no blocking structure, which further improves the sound output effect.

Exemplarily, two ends of the first sound guide member 400 are respectively located at two ends of the second opening, so that the break 401 of the first sound guide member 400 is opposite the second opening. This not only ensures the sound outlet area but also prevents an excessively large sound outlet area that would allow a large amount of dust and other impurities to enter the interior of the sound cavity.

In some embodiments of the present disclosure, the mounting groove 313 formed on the speaker housing 310 omits a portion of a side wall. For example, when the mounting groove 313 is a rectangular groove, it has a groove bottom wall and three groove side walls, with the groove bottom wall facing the rear housing 200. The side of the mounting groove 313 corresponding to the first sound outlet 302 has no groove side wall, which not only simplifies the structure of the speaker housing 310 but also facilitates processing.

For a structure in which a sound outlet is provided in a groove side wall of the mounting groove 313, limited dimensions of the groove side wall impose high processing precision requirements, making the processing of the speaker housing difficult and costly. Moreover, to facilitate processing the sound outlet in the groove side wall, a portion of the groove side wall is thickened to obtain sufficient processing space for the sound outlet, which contradicts the original design intention of a thin speaker in some embodiments of the present disclosure.

In some embodiments of the present disclosure, the mounting groove 313 is provided in the speaker housing 310 to accommodate part of the thickness of the first loudspeaker 320. The first sound guide member 400 is an elastic sound guide member provided between the speaker housing 310 and the rear housing 200 to accommodate another part of the thickness of the first loudspeaker 320, eliminating the need to reserve a separate thickness gap for the first loudspeaker 320. Furthermore, the rear housing 200 is used as a sound guide structure for sound waves, achieving lateral sound emission while further reducing the thickness of the speaker, making it suitable for the limited rear space of the display apparatus 10.

Moreover, in some embodiments of the present disclosure, the first sound guide member 400 is used to form the first sound outlet 302, and the mounting groove 313 omits a portion of a groove side wall, to increase the sound outlet area of the first sound outlet 302 and improve the sound output effect. Additionally, this arrangement facilitates increasing the area of the mounting groove 313, increasing the installation space for the loudspeaker and improving the convenience of loudspeaker installation.

In some embodiments of the present disclosure, the first sound guide member 400 is elastic, so that the speaker housing 310 and the rear housing 200 are elastically connected to each other, and a thickness dimension of the first sound cavity 301 in a front-rear direction of the display apparatus can be elastically increased or decreased, to absorb part of the sound wave energy on the rear housing 200, reduce the vibration force on the rear housing 200, and ensure the stability of the connection structure of the rear housing 200. This is beneficial to reducing the possibility of noise generated by vibration of the rear housing 200 and ensuring the acoustic effect. Moreover, the first sound guide member 400 keeps the space between the speaker housing 310 and the rear housing 200 sealed at all positions other than the first sound outlet 302. That is, the first sound guide member 400 provides a sealing function, reducing the possibility of sound leakage from the first sound cavity 301, and allowing sound waves to be concentrated and emitted from the first sound outlet 302 as much as possible, further improving the sound effect.

Referring back to FIG. 2A, in some embodiments of the present disclosure, the display apparatus further includes a side frame 250 connected between an edge of the rear housing 200 and an edge of the display module 100. The side frame 250 is provided with sound holes 251.

The first sound cavity 301, the first sound outlet 302, and the sound holes 251 form a sound output channel. Sound waves generated by the first loudspeaker 320 are transmitted to the outside of the display apparatus through the sound output channel.

A shape of the side frame 250 is the same as a shape of the display apparatus. The side frame 250 is formed by a bottom side, a top side, a left side, and a right side. When the sound holes 251 are provided on the bottom side of the side frame 250, the display apparatus emits sound from the bottom side, for example, a center channel of the display apparatus. When the sound holes 251 are provided on the top side of the side frame 250, the display apparatus emits sound from the top side, for example, a height audio channel of the display apparatus. When the sound holes 251 are provided on the left side of the side frame 250, the display apparatus emits sound from the left side, for example, a left channel or a surround channel of the display apparatus. When the sound holes 251 are provided on the right side of the side frame 250, the display apparatus emits sound from the right side, for example, a right channel or a surround channel of the display apparatus.

In some embodiments, the side frame 250 and the rear housing 200 may be two separate components, so that the side frame 250 and the rear housing 200 can be processed separately, which is a simple processing method.

In other embodiments, the side frame 250 and the rear housing 200 may be an integral piece, i.e., a peripheral edge of the rear housing 200 is bent and extended toward the display module 100 to form the side frame 250. In this way, the side frame 250 can be directly formed by integrally molding the rear housing 200, reducing assembly steps for the side frame 250 and improving assembly efficiency.

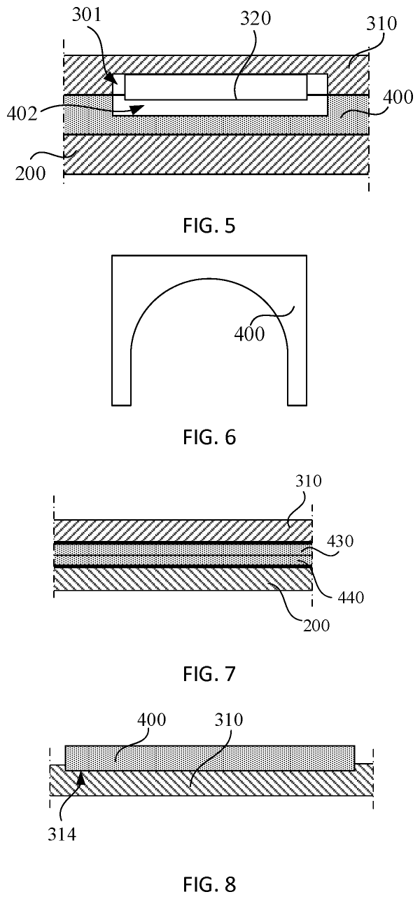

Referring to FIG. 5, the first sound guide member 400 is a closed ring shape, and a surface of the first sound guide member 400 facing the speaker housing 310 is recessed toward the rear housing 200 to form a notch 402. The notch 402 communicates with the first sound cavity 301 and forms at least part of the first sound outlet 302. With such an arrangement, the first sound guide member 400 has a closed ring shape, which provides high structural stability and facilitates installation of the first sound guide member 400.

When the speaker housing 310 is provided with the mounting groove 313, the notch 402 is opposite the second opening of the mounting groove 313, and a portion of the first sound guide member 400 is opposite the mounting groove 313. The notch 402 and the second opening of the mounting groove 313 together form the first sound outlet 302.

Referring again to FIGS. 3 and 4, in some embodiments, the first sound guide member 400 is an integral piece, which facilitates improving the sealing performance of the first sound guide member 400 and prevents sound waves from being emitted through gaps in portions of the first sound cavity 301, which would cause noise.

In other embodiments, the first sound guide member 400 includes a plurality of sound guide strips. The plurality of sound guide strips are spliced together to form the first sound guide member 400 and surround the outside of the first loudspeaker 320. Such an arrangement simplifies the installation of the first sound guide member 400, and allows the use of foam strips, sponge strips, or the like from the existing technology, without requiring special shape design or processing.

For the first sound guide member 400 formed with the break 401, the break 401 can be formed without providing a sound guide strip. For the first sound guide member 400 formed with the notch 402, the notch 402 can be formed by making the sound guide strip at a corresponding position have a smaller thickness.

In some embodiments, the sound guide strips are linear, which further facilitates installation and facilitates forming the first sound cavity 301 with a regular shape, facilitating matching the volume of the first sound cavity 301 with the performance of the first loudspeaker 320.

In some embodiments, the sound guide strips are curved, for example, arc-shaped, which can match the shape of the first loudspeaker 320 and facilitate concentrated emission of sound waves.

As shown in FIGS. 3 and 4, the first sound cavity 301 has a rectangular shape with an opening. The first sound guide member 400 is generally “ [symbol] ”-shaped, with the first sound outlet 302 formed on one side thereof. Such a regular shape facilitates installation and design.

This is not a limitation on the shape of the first sound cavity 301. For example, the first sound cavity 301 may also be circular, elliptical, polygonal, or irregular in shape.

In some embodiments, referring again to FIGS. 3 and 4, an inner side surface of the first sound guide member 400 facing the first sound cavity 301 is planar. This gives the first sound guide member 400 a regular and simple structure, facilitating formation by splicing strip-shaped sound guide strips.

In other embodiments, as shown in FIG. 6, at least part of the inner side surface of the first sound guide member 400 facing the first sound cavity 301 is curved, for example, an arc surface. Such an arrangement makes at least part of the inner side surface of the first sound cavity 301 curved, which can reduce perpendicular reflection of sound waves, reducing peaks and valleys in the sound waves and improving the smoothness of the sound waves.

In some embodiments, the inner side surface of the first sound guide member 400 opposite the first sound outlet 302 is curved.

In some implementations, referring again to FIG. 2A, the first sound guide member 400 is connected to the rear housing 200. For example, the first sound guide member 400 is connected before the rear housing 200 is assembled, providing ample operating space and high connection efficiency. Moreover, when the rear housing 200 is removed for maintenance of the internal structure of the display apparatus, because the first sound guide member 400 is located on the rear housing 200, damage to the first sound guide member 400 due to improper maintenance operations can be reduced.

Exemplarily, the first sound guide member 400 is adhered to the rear housing 200. For example, the first sound guide member 400 is provided with its own adhesive and is adhered to the rear housing 200. As another example, the first sound guide member 400 is adhered to the rear housing 200 using double-sided tape, glue, or the like. Such an arrangement provides a stable and reliable connection, ample operating space, high efficiency, and facilitates disassembly and replacement. Moreover, during the assembly process of the complete display apparatus, the position of the first sound guide member 400 can be easily adjusted to form a sound cavity volume that provides better sound quality.

In other implementations, the first sound guide member 400 is connected to the speaker housing 310. In this way, the first sound guide member 400 forms part of the first speaker 300, and during the assembly process of the display apparatus, no additional step for connecting the first sound guide member 400 is required, which simplifies the assembly process of the display apparatus.

Exemplarily, the first sound guide member 400 is adhered to the speaker housing 310. For example, the first sound guide member 400 is provided with its own adhesive and is adhered to the speaker housing 310. As another example, the first sound guide member 400 is adhered to the speaker housing 310 using double-sided tape, glue, or the like. Such an arrangement provides a stable and reliable connection, simple operation, high efficiency, and facilitates disassembly and replacement. Moreover, with the first sound guide member 400 adhered to the speaker housing 310 to form part of the speaker, during the assembly process of the complete display apparatus, no additional positioning or adhesion operation of the first sound guide member 400 on the rear housing 200 is required, which is beneficial to improving the assembly efficiency of the entire device. The position of the first sound guide member 400 adhered to the speaker housing 310 is more accurate, facilitating the formation of a predetermined sound cavity volume and reducing the possibility that positional deviation of the first sound guide member 400 would affect the sound cavity volume.

In still other embodiments, the first sound guide member 400 is connected to both the speaker housing 310 and the rear housing 200, providing a stable and reliable connection. By configuring the connection between the speaker housing 310 and the rear housing 200, when the rear housing 200 is removed for maintenance of the display apparatus, the entire first speaker 300 may be removed together with the rear housing 200. Alternatively, when the first sound guide member 400 is made of a material such as sponge or foam, the rear housing 200 may be detached by destroying the first sound guide member 400, and the first sound guide member 400 is replaced with a new one during reassembly.

In some embodiments, as shown in FIG. 7, the first sound guide member 400 includes a first sound guide layer 430 and a second sound guide layer 440 disposed in a stacked manner. The first sound guide layer 430 is connected to the speaker housing 310, for example, adhered to the speaker housing 310. The second sound guide layer 440 is connected to the rear housing 200, for example, adhered to the rear housing 200. The first sound guide layer 430 and the second sound guide layer 440 are in contact with each other, to form the first sound guide member 400. Such an arrangement not only ensures the stability of the connection of the first sound guide member 400, but also improves the sound wave guiding function of the first sound guide member 400, allowing sound waves to be emitted from the first sound outlet.

Areas of the first sound guide layer 430 and the second sound guide layer 440 in a plane parallel to the display surface may be equal. When the first speaker 300 is mounted on the rear housing 200, the first sound guide layer 430 is in contact with the second sound guide layer 440. Alternatively, the area of one sound guide layer may be larger than the area of the other sound guide layer. For example, the area of the first sound guide layer 430 may be larger than the area of the second sound guide layer 440. As another example, the area of the second sound guide layer 440 may be larger than the area of the first sound guide layer 430. This ensures contact between the two sound guide layers and avoids misalignment caused by assembly errors, processing precision, or the like.

In some embodiments, the entire first sound guide member 400 is mounted on the speaker housing 310, or the entire first sound guide member 400 is mounted on the rear housing 200, which is a relatively simple mounting method.

In other embodiments, a portion of the first sound guide member 400 is connected to the speaker housing 310, and another portion of the first sound guide member 400 is connected to the rear housing 200. Exemplarily, when the first sound guide member 400 includes a plurality of sound guide strips, some of the sound guide strips are connected to the speaker housing 310, and some of the sound guide strips are connected to the rear housing 200. Such an arrangement provides flexibility in connecting the first sound guide member 400, facilitating flexible operations during assembly of the display apparatus.

Exemplarily, if a portion of the first sound guide member 400 connected to the speaker housing 310 is damaged or fails due to improper transportation or other reasons, some sound guide strips may be connected to the rear housing 200 so that the sound guide strips on the speaker housing 310 and the sound guide strips on the rear housing 200 together form the first sound guide member 400, avoiding the need to return the entire first speaker 300 to the factory for repair and improving production efficiency.

In some embodiments, the first sound guide member 400 is sandwiched between the speaker housing 310 and the rear housing 200, so that the first sound guide member 400 is elastically compressed between the speaker housing 310 and the rear housing 200. This eliminates the need for an additional step of connecting the first sound guide member 400, which is beneficial to improving production efficiency.

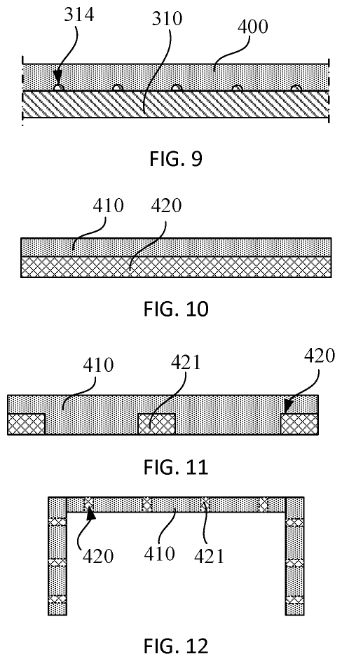

When mounted in this way, the position of the first sound guide member 400 is prone to movement and requires repeated adjustment. In view of this, in some embodiments, with reference to FIGS. 8 and 9, the speaker housing 310 is provided with a limiting portion 314 that cooperates with the first sound guide member 400 to restrict the position of the first sound guide member 400.

Exemplarily, referring to FIG. 8, the limiting portion 314 may be a groove provided on the speaker housing 310. Exemplarily, referring to FIG. 9, the limiting portion 314 may be a protrusion or a bump provided on the speaker housing 310. Such an arrangement not only restricts the position of the first sound guide member 400 but also improves the structural strength of the speaker housing 310.

Of course, in some embodiments, the limiting portion 314 may be provided on the rear housing 200. In this way, the limiting portion 314 can be integrally formed when the rear housing 200 is molded, without adding an additional process.

In yet other embodiments, the speaker housing 310 and the rear housing 200 are each provided with a limiting portion 314 that cooperates with the first sound guide member 400, improving the reliability of restricting the position of the first sound guide member 400, reducing assembly difficulty, and improving assembly efficiency.

Referring again to FIGS. 3 and 4, the first sound guide member 400 elastically connects the speaker housing 310 and the rear housing 200. Thus, when the rear housing 200 bears vibrating sound waves, the first sound guide member 400 deforms under the vibration force, absorbing the vibration force and avoiding noise caused by rigid contact between the rear housing 200 and the speaker housing 310.

In some implementations, at least part of the first sound guide member 400 is elastic. As shown in FIGS. 10 and 11, the first sound guide member 400 includes an elastic portion 410. The elastic portion 410 may contact the speaker housing 310 or the rear housing 200, to elastically connect the speaker housing 310 and the rear housing 200.

The first sound guide member 400 includes a rigid portion 420. The rigid portion 420 can provide support and limitation for the elastic portion 410, helping to maintain the shape of the first sound guide member 400. The rigid portion 420 can also provide a mounting structure for the first sound guide member 400, ensuring reliable mounting of the first sound guide member 400. One of the speaker housing 310 and the rear housing 200 is connected to the rigid portion 420, and the other one of the speaker housing 310 and the rear housing 200 is connected to the elastic portion 410.

The rigid portion 420 is fixedly connected to the speaker housing 310 or the rear housing 200. For example, the rigid portion 420 is adhered to the speaker housing 310 or the rear housing 200, which is a simple connection method. As another example, the rigid portion 420 is snap-fitted to the speaker housing 310 or the rear housing 200, providing a stable connection.

In some embodiments, as shown in FIG. 10, the elastic portion 410 and the rigid portion 420 of the first sound guide member 400 are arranged in a stacked manner. Such an arrangement allows the first sound guide member 400 to have a rigid portion 420 with a relatively large area, facilitating installation and fixation of the first sound guide member 400.

Exemplarily, one of the speaker housing 310 and the rear housing 200 is adhered to the rigid portion 420, and the other one of the speaker housing 310 and the rear housing 200 contacts the elastic portion 410. With such an arrangement, the adhesion of the rigid portion 420 is more stable and reliable, and the contact of the elastic portion 410 provides elastic connection between the speaker housing 310 and the rear housing 200.

In other embodiments, as shown in FIG. 11, the rigid portion 420 of the first sound guide member 400 includes a plurality of rigid members 421. The plurality of rigid members 421 are arranged at intervals, providing support for the elastic portion 410 while reducing the amount of rigid portion 420 provided. This not only reduces the material consumption of the rigid portion 420 but also reduces the weight of the first sound guide member 400, which is beneficial to the slim design of the display apparatus.

In some embodiments, as shown in FIG. 12, the rigid portion 420 of the first sound guide member 400 includes a plurality of rigid members 421. The plurality of rigid members 421 are arranged at intervals along an extension direction of the elastic portion 410. When the elastic portion 410 is formed by splicing a plurality of elastic segments, the plurality of rigid members 421 are arranged at intervals along a length direction of each elastic segment. The elastic portion 410 has a relatively large dimension along the extension direction of the elastic portion 410, while the elastic portion 410 has a relatively small dimension along a width direction of the elastic portion 410. Arranging the plurality of rigid members 421 at intervals along the extension direction of the elastic portion 410 not only provides sufficient arrangement space but also facilitates supporting the elastic portion 410 and helps maintain the shape of the first sound guide member 400.

In other implementations, the first sound guide member 400 is an elastic member, for example, an elastic rubber piece, foam, sponge, or the like. With such an arrangement, the first sound guide member 400 is an integral piece, which not only provides better sealing and reduces the possibility of sound leakage from the sound cavity, but also provides sufficient elastic deformation force to ensure elastic connection between the speaker housing 310 and the rear housing 200. Moreover, an elastic member structure from the existing technology may be used, requiring no additional processing or design, resulting in a simple structure.

If a thickness of the first sound guide member 400 is less than 2 mm, the elastic deformation is small, which may easily cause the diaphragm of the first loudspeaker 320 to contact the rear housing 200, generating noise or even causing damage. Here, the thickness of the first sound guide member 400 refers to the dimension of the first sound guide member 400 along a thickness direction of the display apparatus.

In some embodiments, the thickness of the first sound guide member 400 is greater than or equal to 2 mm, ensuring that the first sound guide member 400 has a certain thickness and elastic force, and preventing contact between the rear housing 200 and the speaker housing 310.

If the thickness of the first sound guide member 400 is greater than 4 mm, the first sound guide member 400 becomes relatively thick, increasing the overall thickness of the first speaker 300, which is detrimental to the thinning design of the speaker.

In some embodiments, the thickness of the first sound guide member 400 is less than or equal to 4 mm. Such an arrangement not only allows the first sound guide member 400 to have a certain thickness to provide a vibration gap for the diaphragm of the first loudspeaker 320, but also allows the first sound guide member 400 to have sufficient elastic deformation, which is beneficial to prolonging the service life of the first sound guide member 400.

In some embodiments, the thickness of the first sound guide member 400 may range from 2 mm to 4 mm. For example, the thickness of the first sound guide member 400 may be 2 mm to 2.5 mm, 2.5 mm to 3 mm, 3 mm to 3.5 mm, or 3.5 mm to 4 mm. Exemplarily, the thickness of the first sound guide member 400 may be 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, or 4.0 mm, etc.

Such an arrangement allows the first sound guide member 400 to have sufficient thickness to ensure elastic connection between the rear housing 200 and the speaker housing 310, while also preventing an excessive increase in the overall thickness of the speaker due to an overly thick first sound guide member 400, which would be detrimental to reducing the thickness of the speaker.

If the width of the first sound guide member 400 is less than 8 mm, the first sound guide member 400 may provide poor support, be easily penetrated by sound waves, causing sound leakage and other problems, and affecting sound quality. The width of the first sound guide member 400 refers to a dimension along a width direction of a sound guide strip forming the first sound guide member 400. The sound guide strip extends along a length direction of the sound guide strip, and the width direction of the sound guide strip is perpendicular to the length direction of the sound guide strip.

In some embodiments, the width of the first sound guide member 400 is greater than or equal to 8 mm. Such an arrangement ensures that the first sound guide member 400 has sufficient width to provide stable and reliable elastic support for the first speaker 300 and to guide the sound waves.

If the width of the first sound guide member 400 is greater than 10 mm, the first sound guide member 400 not only occupies a large installation space but also consumes more material.

In some embodiments, the width of the first sound guide member 400 is less than or equal to 10 mm. Such an arrangement ensures that the first sound guide member 400 has sufficient width to form the first sound cavity 301, while also reducing the material consumption of the first sound guide member 400.

In some embodiments, the width of the first sound guide member 400 may range from 8 mm to 10 mm, for example, 8 mm to 9 mm or 9 mm to 10 mm. Exemplarily, the width of the first sound guide member 400 may be 8 mm, 8.2 mm, 8.4 mm, 8.5 mm, 8.6 mm, 8.8 mm, 9.0 mm, 9.1 mm, 9.2 mm, 9.4 mm, 9.5 mm, 9.6 mm, 9.8 mm, 10.0 mm, etc.

Such an arrangement not only allows the first sound guide member 400 to have sufficient width to provide stable and reliable elastic support for the first speaker 300, but also prevents the first sound guide member 400 from being too wide and occupying excessive installation space.

In some embodiments, a density of the first sound guide member 400 is greater than or equal to 24 kg/m³. Such an arrangement ensures that the first sound guide member 400 has sufficient elastic force while also guiding sound waves, allowing the sound waves to be emitted from the sound outlet.

If the density of the first sound guide member 400 is less than 24 kg/m³, the elastic force of the first sound guide member 400 may be insufficient, easily causing rigid contact between the rear housing 200 and the speaker housing 310. Moreover, sound waves may easily pass through the first sound guide member 400, causing sound leakage and other problems that affect sound quality.

If the density of the first sound guide member 400 is greater than 26 kg/m³, the elastic force of the first sound guide member 400 may be too large, making it easy for sound waves to be transmitted to the rear housing 200 through the first sound guide member 400, which may easily generate noise.

In some embodiments, the density of the first sound guide member 400 is less than or equal to 26 kg/m³. Such an arrangement allows the first sound guide member 400 to be easily elastically deformed, increasing the elastic force between the rear housing 200 and the speaker housing 310, reducing the problem of noise caused by rigid connection between the rear housing 200 and the speaker housing 310, while still guiding sound waves.

In some embodiments, the density of the first sound guide member 400 is greater than or equal to 24 kg/m³ and less than or equal to 26 kg/m³. For example, the density of the first sound guide member 400 may range from 24 kg/m³ to 24.5 kg/m³, 24.5 kg/m³ to 25 kg/m³, 25 kg/m³ to 25.5 kg/m³, or 25.5 kg/m³ to 26 kg/m³.

Such an arrangement allows the first sound guide member 400 to be easily elastically deformed, increasing the elastic force between the rear housing 200 and the speaker housing 310, reducing the problem of noise caused by rigid connection between the rear housing 200 and the speaker housing 310, while still guiding sound waves.

With continued reference to FIGS. 3 and 4, in some embodiments, a plurality of first loudspeakers 320 may be provided, for example, two, three, four, or more. The plurality of first loudspeakers 320 are arranged at intervals along a length direction of the first sound outlet 302, and all of the plurality of first loudspeakers 320 are disposed within the same first sound cavity 301. In this way, the first sound guide member 400 surrounds outsides of all the first loudspeakers 320. The plurality of first loudspeakers 320 can share one first sound outlet 302, allowing sound waves to be concentrated and emitted from the first sound outlet 302, to improve the acoustic effect. Moreover, a plurality of loudspeakers can be arranged in a limited space, improving the sound output effect.

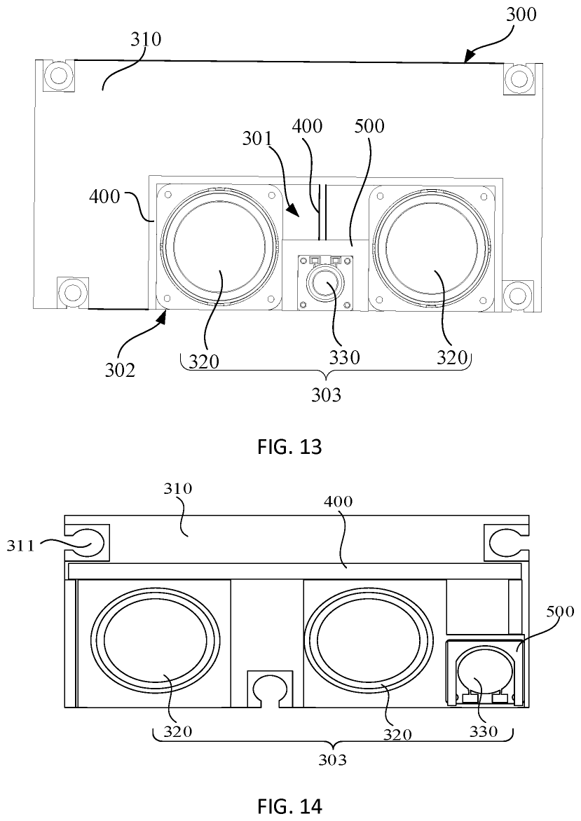

In some embodiments, referring to FIG. 13, a plurality of first loudspeakers 320 are provided, and a plurality of first sound cavities 301 are provided. At least one first loudspeaker 320 is independently disposed in one first sound cavity 301. First sound outlets 302 of the plurality of first sound cavities 301 are all located on the same side of the speaker housing 310, which is beneficial to ensuring the directionality of sound emission.

In some embodiments, each first loudspeaker 320 is respectively disposed in one first sound cavity 301, which can reduce interference between different loudspeakers.

Compared with providing a relatively large first sound cavity 301 to accommodate all the first loudspeakers 320, the above arrangement provides a plurality of relatively small first sound cavities 301, increasing support positions of the first sound guide member 400, ensuring elastic connection between the rear housing 200 and the speaker housing 310, and reducing noise caused by rigid contact between the rear housing 200 and the speaker housing 310 due to insufficient elastic support of the first sound guide member 400.

With continued reference to FIG. 4, in some embodiments, the first speaker 300 further includes a second loudspeaker 330. The second loudspeaker 330 is mounted on the speaker housing 310 and is located within the first sound cavity 301.

In some embodiments, the mounting groove 313 has a relatively large dimension, so that the second loudspeaker 330 and the first loudspeaker 320 can share one mounting groove 313. Such an arrangement simplifies the structure of the speaker housing 310.

In other embodiments, a plurality of mounting grooves 313 may be provided, and the second loudspeaker 330 and the first loudspeaker 320 are respectively mounted in the mounting grooves 313. Such an arrangement results in mounting grooves 313 of relatively small dimension, which is beneficial to ensuring the structural strength of the speaker housing 310.

In some embodiments, at least part of the sound wave frequency of the second loudspeaker 330 is different from the sound wave frequency of the first loudspeaker 320. For example, part of the sound wave frequency of the second loudspeaker 330 is higher than the sound wave frequency of the first loudspeaker 320.

Exemplarily, the second loudspeaker 330 may be a tweeter, and the sound wave frequency range of the second loudspeaker 330 may be 2 KHz to 20 KHz. The first loudspeaker 320 may be a midrange loudspeaker, and the sound wave frequency range of the first loudspeaker 320 may be 200 Hz to 8 KHz, or 200 Hz to 10 KHz.

In some embodiments, the sound wave frequency of the second loudspeaker 330 is higher than the sound wave frequency of the first loudspeaker 320.

In some embodiments of the present disclosure, loudspeakers of the first speaker 300 cooperate by combining midrange and treble frequencies to improve the acoustic effect of the display apparatus.

In some embodiments, no sound guide member is provided outside the second loudspeaker 330. When the first loudspeaker 320 is a full-range loudspeaker and the second loudspeaker 330 is a tweeter, an installation distance between the first loudspeaker 320 and the second loudspeaker 330 is relatively short, and there is insufficient space to provide a sound guide member, so that the second loudspeaker 330 and the first loudspeaker 320 share one sound cavity, which simplifies the speaker structure.

In some embodiments, the display apparatus 10 further includes a second sound guide member 500. The second sound guide member 500 is located within the first sound cavity 301 and is in contact with both the rear housing 200 and the speaker housing 310. The second sound guide member 500, the rear housing 200, and the speaker housing 310 together enclose a second sound cavity 501. The second sound guide member 500 forms a second sound outlet 502 on a side of the first sound outlet 302. The second loudspeaker 330 is located within the second sound cavity 501.

In this embodiment, by providing the second sound guide member 500 within the first sound cavity 301, the second sound cavity 501 is formed to accommodate the second loudspeaker 330. In this way, the second sound cavity 501 can isolate the second loudspeaker 330 from the first loudspeaker 320, and reduce the possibility of noise caused by resonance between the first loudspeaker 320 and the second loudspeaker 330 within the first sound cavity 301. A sound emission direction of the second loudspeaker 330 is the same as a sound emission direction of the first loudspeaker 320, which also ensures that sound waves are mixed and emitted together, ensuring the acoustic effect of the display apparatus.

The structure, connection method, and the like of the second sound guide member 500 may refer to those of the first sound guide member 400.

In some embodiments of the present disclosure, by providing the second sound guide member 500, the second loudspeaker 330 and the first loudspeaker 320 are located in different sound cavities, reducing interference between different loudspeakers and improving sound quality.

As shown in FIGS. 3 and 4, in some embodiments, a plurality of first loudspeakers 320 are provided. One second loudspeaker 330 may be provided, and the second loudspeaker 330 may be disposed between two adjacent first loudspeakers 320. Exemplarily, two first loudspeakers 320 are provided, and the second loudspeaker 330 is disposed between the two first loudspeakers 320, and the two first loudspeakers 320 are arranged symmetrically with respect to the second loudspeaker 330. Such an arrangement improves the appearance characteristics of the first speaker 300.

As shown in FIG. 14, in some embodiments, a plurality of first loudspeakers 320 are provided, and the second loudspeaker 330 is disposed at an end of the entirety of the plurality of first loudspeakers 320. When the first speaker 300 is mounted on a top side or a bottom side of the display apparatus, such an arrangement facilitates arranging a loudspeaker with a higher frequency on a side away from a vertical centerline of the display apparatus, which is beneficial to improving the stereo effect and widening the sound field of the display apparatus.

In some embodiments, two first loudspeakers 320 and one second loudspeaker 330 are combined to form a sound generating unit 303, and the sound generating unit 303 is disposed within the same first sound cavity 301. Such an arrangement allows that, when the first speaker 300 is relatively thin, and a single first loudspeaker 320 cannot meet the requirements in terms of sound generation performance, power, etc., the combination of two first loudspeakers 320 and one second loudspeaker 330 is adopted to improve sound generation performance such as frequency bandwidth and sound loudness, improving the acoustic effect.

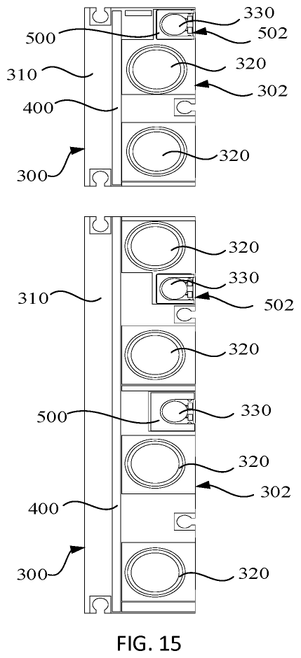

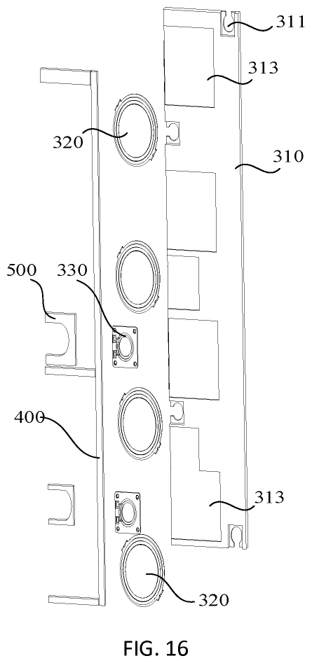

Referring to FIGS. 15 and 16, in some embodiments, the first speaker 300 is provided with a plurality of first loudspeakers 320 and a plurality of second loudspeakers 330. The plurality of first loudspeakers 320 are arranged at intervals along a length direction of the speaker housing 310, and the plurality of second loudspeakers 330 are arranged at intervals along the length direction of the speaker housing 310, to increase frequency bandwidth, sound loudness, and other acoustic performance.

In the structure shown in FIG. 15, two first speakers 300 are provided, and the two first speakers 300 include different numbers of loudspeakers. A person skilled in the art may set the number of loudspeakers in the first speaker 300 according to actual arrangement space, acoustic requirements, etc. In some possible implementations, the structure shown in FIG. 15 may serve as a surround channel speaker of the display apparatus.

In some possible implementations, the plurality of first loudspeakers 320 are arranged at uniform intervals along the length direction of the speaker housing 310 to improve the surround effect of sound produced by the display apparatus.

In some embodiments, the number of second loudspeakers 330 is half the number of first loudspeakers 320. That is, the number of first loudspeakers 320 is twice the number of second loudspeakers 330. In this way, two first loudspeakers 320 and one second loudspeaker 330 can be combined to form a sound generating unit 303, improving acoustic efficiency.

When the first speaker 300 has a plurality of sound generating units 303, the position of the second loudspeaker 330 within each sound generating unit 303 may vary. For example, the second loudspeaker 330 may be disposed between two first loudspeakers 320. As another example, the second loudspeaker 330 may be disposed at an end of the sound generating unit 303.

The first speaker 300 may include one sound generating unit 303, making the first speaker 300 compact and flexible in installation position.

The first speaker 300 may include a plurality of sound generating units 303, providing the first speaker 300 with sufficient frequency bandwidth, sound loudness, etc., and improving the surround effect.

In some embodiments, the first speaker 300 may be located on a bottom side of the rear housing 200, and the first sound outlet 302 faces downward, so that the first speaker 300 emits sound downward.

In some embodiments, the first speaker 300 may be located on a left side of the rear housing 200, and the first sound outlet 302 faces left, so that the first speaker 300 emits sound leftward. The first speaker 300 may be located on a right side of the rear housing 200, and the first speaker 300 emits sound rightward.

In the above description, both the first loudspeaker 320 and the second loudspeaker 330 use the rear housing 200 and the sound guide member for sound wave guidance, which is not limiting.

For example, in some embodiments, the first loudspeaker 320 may be a midrange loudspeaker, and the second loudspeaker 330 may be a tweeter. The first loudspeaker 320 uses the rear housing 200 and the first sound guide member 400 to guide sound waves, and a sound guide partition is provided on a side of the second loudspeaker 330 facing the rear housing 200 to guide sound waves to lateral emission.

As another example, in some embodiments, the first loudspeaker 320 may be a tweeter, and the second loudspeaker 330 may be a midrange loudspeaker. The first loudspeaker 320 uses the rear housing 200 and the first sound guide member 400 to guide sound waves, and a sound guide partition is provided on a side of the second loudspeaker 330 facing the rear housing 200 to guide sound waves to lateral emission.

In some embodiments, with continued reference to FIGS. 3 and 4, the first speaker 300 further includes a third loudspeaker 340. The third loudspeaker 340 is mounted on a side of the speaker housing 310 facing the rear housing 200, and a gap is provided between a diaphragm of the third loudspeaker 340 and the rear housing 200 to reserve a gap for vibration of the diaphragm of the third loudspeaker 340.

In some embodiments, the third loudspeaker 340 is a woofer, and a sound wave frequency of the third loudspeaker 340 may be lower than 200 Hz. No sound guide member needs to be provided outside the third loudspeaker 340. The third loudspeaker 340 is a woofer and has low directivity requirements for sound waves.

Taking the first speaker 300 shown in FIG. 16 as an example, in some embodiments, the thickness of the speaker housing 310 may be 9 mm, and the volume of the speaker housing 310 may be 0.4 L.

Two first loudspeakers 320 of the first speaker 300 shown in FIG. 16 are full-range loudspeakers with a rated power of 12 W. Two second loudspeakers 330 are tweeters with a rated power of 12 W. A frequency range of the loudspeakers of the first speaker 300 is 200 Hz to 20 KHz. A distortion rate of the first speaker 300 is less than or equal to 7%. A characteristic sensitivity level of the first speaker 300 is greater than or equal to 78 dB.

The inventors of the present disclosure have found through research that sound produced by a display apparatus may have peaks and valleys in certain frequency bands of the sound frequency response curve, resulting in uneven sound and affecting sound quality. After repeated research, it has been found that because the loudspeaker transmits sound waves toward the opposite speaker housing wall, the sound waves are reflected by the housing and change direction before being emitted through the side sound outlet. Due to the back-and-forth reflection of sound waves within the speaker housing, peaks and valleys easily appear in certain frequency bands, causing uneven sound and affecting sound quality. Particularly for a woofer, an amplitude and airflow of the woofer are relatively large, and sound waves are directly transmitted to the rear housing 200, causing larger vibration of the rear housing 200 and generating noises easily.

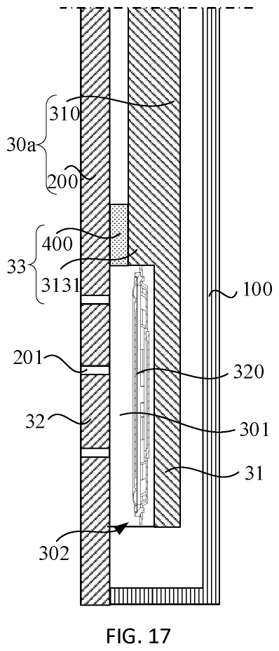

In view of this, in some embodiments, with reference to FIG. 17, a portion of a housing wall of a first housing 30a is provided with sound outlet holes 201. The housing wall provided with the sound outlet holes 201 is opposite to and spaced apart from the first loudspeaker 320.

In some embodiments of the present disclosure, a sound emission direction of the sound outlet holes 201 is different from a sound emission direction of the first sound outlet 302. The sound emission direction of the sound outlet holes 201 faces the diaphragm of the first loudspeaker 320, and the first sound outlet 302 is located at a side of the first loudspeaker 320.

The first housing 30a is part of the first speaker 300, and the first housing 30a is configured to form the first sound cavity 301 for accommodating the first loudspeaker 320.

In some embodiments, the first housing 30a may be formed by the speaker housing 310, the rear housing 200, and the first sound guide member 400 as described in some of the above embodiments. Such an arrangement is beneficial to reducing the thickness of the speaker. In this case, the rear housing 200 is provided with sound outlet holes 201 in a region opposite the diaphragm of the loudspeaker. For example, the rear housing 200 is provided with sound outlet holes 201 in a region opposite the first loudspeaker 320. As another example, the rear housing 200 is provided with sound outlet holes 201 in a region opposite the second loudspeaker 330. As yet another example, the rear housing 200 is provided with sound outlet holes 201 in a region opposite the third loudspeaker 340.

In other embodiments, the first housing 30a is a structure independent of the rear housing 200, and a gap is provided between the first housing 30a and the rear housing 200 to prevent vibration of the first housing 30a from causing vibration of the rear housing 200. In this case, a housing wall of the first housing 30a opposite the rear housing 200 is provided with sound outlet holes 201.

Exemplarily, the first housing 30a includes the above-mentioned speaker housing 310 and a sound guide baffle, and the sound guide baffle and the speaker housing 310 together enclose the first sound cavity 301. The sound guide baffle is spaced apart from the rear housing 200.

The first housing 30a provided independently of the rear housing 200 makes the speaker a closed structure, facilitating transportation and protecting the internal structure, but requires a larger installation space compared to some of the above embodiments.

In some embodiments of the present disclosure, by providing the sound outlet holes 201, part of the sound waves can be emitted from the sound outlet holes 201, reducing a reflection path of the sound waves within the first sound cavity 301, reducing back-and-forth reflection of the sound waves in the first sound cavity 301, which in turn attenuates peaks and valleys of the sound frequency response curve in certain frequency bands, improves smoothness of the sound, and thus improves sound quality.

Moreover, providing the sound outlet holes 201 in the rear housing 200 in a region corresponding to the third loudspeaker 340 helps to reduce the vibration force of sound waves on the rear housing 200, and also increases the transmission direction of low-frequency sound waves, allowing the low-frequency sound waves of the first speaker 300 to be emitted both laterally (e.g., toward a bottom side of the display apparatus) and rearward, improving the acoustic effect.

In some embodiments, the sound outlet holes 201 may be circular holes, which are easy to process, and walls of circular holes are smooth, which can reduce stress concentration. Compared with polygonal holes having the same maximum aperture, circular holes have a larger hole area. When providing the same sound outlet area, the number of circular holes is smaller, which can reduce the impact on the structural strength of the housing wall. In some embodiments, an aperture of the sound outlet holes 201 may be 2.5 mm to 3.5 mm, which can avoid problems of high processing difficulty and high cost caused by an excessively small aperture, and also prevent an excessively large aperture that would affect the structural strength of the first housing 30a.

In some embodiments, a plurality of sound outlet holes 201 are provided, and the plurality of sound outlet holes 201 may be arranged in a rectangular matrix, a circular matrix, or the like, which can increase the area for sound wave emission and also improve aesthetics of the rear housing 200.

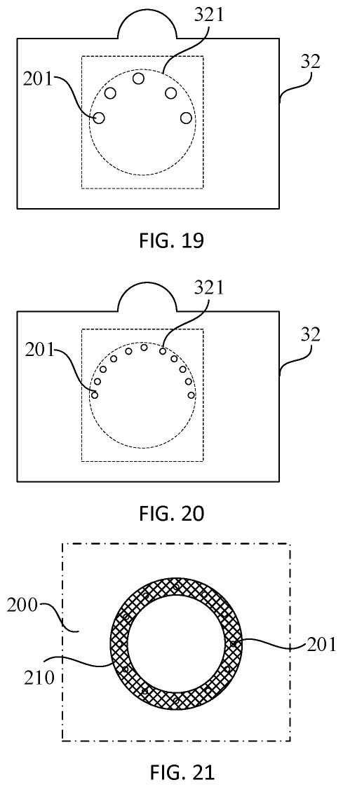

In some embodiments, with reference to FIG. 19, a projection shape of a diaphragm 321 of the first loudspeaker on the rear housing wall 32 is circular. The plurality of sound outlet holes 201 are arranged within a projection region of the diaphragm 321 on the rear housing wall 32. In other words, the plurality of sound outlet holes 201 all face the diaphragm 321 of the first loudspeaker along their axial direction. Such an arrangement facilitates emission of sound waves through the sound outlet holes 201, reduces the reflection path of the sound waves within the first sound cavity 301, reducing back-and-forth reflection of the sound waves in the first sound cavity 301, which in turn attenuates peaks and valleys of the sound frequency response curve in certain frequency bands, improves the smoothness of the sound, and thus improves sound quality.

The sound outlet holes 201 may face an edge of the diaphragm 321, or may face a central region of the diaphragm 321. Arrangement positions of the sound outlet holes 201 are set according to frequency bands corresponding to the peak and valley positions of the sound frequency response curve, to attenuate the peaks and valleys in these frequency bands and make the sound smooth.

Since sound waves are concentrated and emitted through the sound outlet holes 201, airflow noise is easily generated at the sound outlet holes 201, causing noise and affecting the acoustic effect of the display apparatus. Here, airflow noise refers to friction sound generated between the airflow and the sound outlet holes 201 when a vortex flow velocity reaches a certain value. If an airflow velocity at positions of the sound outlet holes 201 reaches 20 m/s, airflow noise perceptible to the human ear, also called “wind noise”, may be generated.

In view of this, in some embodiments, a cross-sectional area of the sound outlet holes 201 is reduced. For example, when the sound outlet holes 201 are circular holes, a diameter of the sound outlet holes 201 is reduced. Exemplarily, the diameter of the sound outlet holes 201 may be within a certain range. Moreover, an arrangement density of the sound outlet holes 201 is increased. It can be understood that the total sound outlet area of all the sound outlet holes 201 shown in FIG. 19 is the same as that shown in FIG. 20. The number of sound outlet holes 201 shown in FIG. 20 is greater than that shown in FIG. 19, and the aperture of the sound outlet holes 201 shown in FIG. 20 is smaller than that shown in FIG. 19.

By increasing the number of sound outlet holes 201 and reducing the area of each sound outlet hole 201, the airflow velocity through each sound outlet hole 201 is reduced, to alleviate the airflow noise. However, the above method not only increases processing difficulty and cost, but also affects the structural strength of the housing.

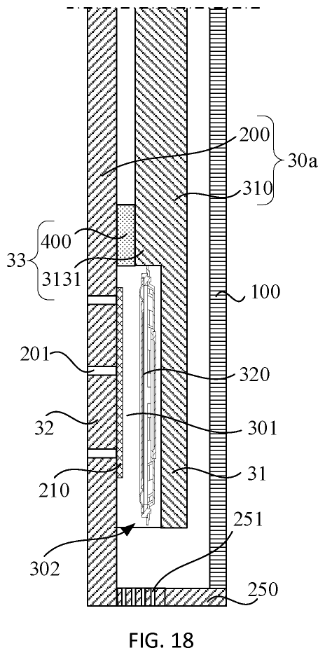

In some embodiments, referring to FIG. 18, a damping component 210 is provided on a housing wall provided with the sound outlet holes 201. The damping component 210 is configured to provide a damping effect on gas flow within the sound outlet holes 201, reducing the possibility of airflow noise at the sound outlet holes 201, reducing wind noise, and improving the sound quality of the display apparatus.

The damping component 210 covers at least some of the sound outlet holes 201 to partition the sound outlet holes 201, forming a plurality of small holes. The damping component 210 increases the resistance to gas flowing through the sound outlet holes 201, reducing the gas flow velocity, alleviating airflow noise.

In some embodiments of the present disclosure, the damping component 210 covers all of the sound outlet holes 201, providing a damping effect on gas flow through each sound outlet hole 201 and alleviating airflow noise.

In some embodiments, the first housing 30a has a front housing wall 31, a rear housing wall 32, and a circumferential side wall 33. The front housing wall 31 and the rear housing wall 32 are opposite to each other and spaced apart along a front-rear direction of the display apparatus. The front housing wall 31 faces the display module 100, and the rear housing wall 32 is provided with the sound outlet holes 201. The circumferential side wall 33 is connected between the front housing wall 31 and the rear housing wall 32, and the circumferential side wall 33 is provided with the first sound outlet 302. Such an arrangement achieves lateral sound emission of the first speaker 300.

In some embodiments, at least part of the first housing 30a is a metal plate portion. For example, at least part of the front housing wall 31 is a metal plate portion, or at least part of the rear housing wall 32 is a metal plate portion. This helps to improve the structural strength of the first housing 30a and reduce deformation of the first housing 30a.

In some embodiments, the first housing 30a includes a metal plate portion and an injection-molded plate portion. The metal plate portion may be adhered to the injection-molded plate portion, providing a simple connection method. Alternatively, the metal plate portion may be used as an insert during injection molding of the injection-molded plate portion, integrally formed with the injection-molded plate portion, providing a stable and reliable connection. The injection-molded plate portion may be a plastic plate portion.

In some embodiments, a magnetic yoke of the first loudspeaker 320 contacts the metal plate portion, which is beneficial to increasing a heat dissipation area of the first loudspeaker 320, improving a heat dissipation effect of the first loudspeaker 320.

When the rear housing 200 forms part of the first housing 30a, the rear housing 200 forms the rear housing wall 32 of the first housing 30a, the speaker housing 310 forms the front housing wall 31 of the first housing 30a, and the first sound guide member 400 and a groove side wall 3131 of the mounting groove 313 together form the circumferential side wall 33 of the first housing 30a.

In some embodiments, the housing wall of the first housing 30a provided with the sound outlet holes 201 has an inner surface facing the first sound cavity 301 and an outer surface opposite the inner surface.

In some embodiments, with reference to FIG. 18, the damping component 210 is provided on the inner surface of the housing wall, so that the damping component 210 is hidden inside the first housing 30a, facilitating protection of the damping component 210.

In other embodiments, the damping component 210 is provided on the outer surface of the housing wall, facilitating replacement and maintenance of the damping component 210 and avoiding the damping component 210 occupying internal space of the housing.

In yet other embodiments, the damping component 210 is provided within the sound outlet holes 201. Such an arrangement not only facilitates replacement and maintenance of the damping component 210, but also prevents the damping component 210 from increasing the thickness of the first speaker 300.

In some embodiments of the present disclosure, the damping component 210 has a porous structure. The damping component 210 is configured to absorb sound waves from the sound outlet holes 201. When sound waves pass through the damping component 210, the damping component 210 provides a damping effect. Air and pore walls of the damping component 210 vibrate and rub against each other, causing part of the sound energy to be converted into heat and absorbed, reducing airflow noise.

In some embodiments, the damping component 210 is a sheet-like structure. Such an arrangement allows the damping component 210 to occupy less thickness space for installation and has little impact on the overall weight of the display apparatus.

In some embodiments, the damping component 210 is a mesh cover having pores. The mesh cover is formed by interwoven mesh wires. The damping component 210 is uniformly provided with a plurality of mesh openings. A cross-sectional area of the mesh opening is smaller than a cross-sectional area of the sound outlet hole 201. Such an arrangement allows part of the mesh wires of the mesh cover to face the sound outlet holes 201. The mesh wires of the mesh cover are configured to cover at least some (e.g., one or more) of the sound outlet holes 201, partitioning relatively large sound outlet holes 201 into a plurality of smaller holes, and increasing the resistance to air flow with reduced airflow noise.

When the mesh openings of the damping component 210 are circular holes and the sound outlet holes 201 are circular holes, an aperture of the damping component 210 is smaller than an aperture of the sound outlet holes 201.

Exemplarily, when the aperture of the sound outlet holes 201 is 2.5 mm to 3.5 mm, a mesh count of the damping component 210 may be 300 mesh, so that the aperture of the damping component 210 is much smaller than the aperture of the sound outlet holes 201, reducing the wind noise problem of the sound outlet holes 201.

In some embodiments, the damping component 210 is a mesh fabric. Mesh openings of the mesh fabric have an area smaller than the cross-sectional area of the sound outlet holes 201, so that the mesh fabric can cover the sound outlet holes 201 and provide a damping effect on gas flow through the sound outlet holes 201. The mesh fabric is a fabric having mesh openings, which may be formed by interwoven yarns, presenting a mesh structure. This structure makes the mesh fabric breathable, allowing sound waves to still be emitted through the sound outlet holes 201. The mesh fabric also has softness and a certain elasticity, which is beneficial to improving the damping effect on airflow. The mesh fabric also has a certain wear resistance, which is beneficial to improving the service life.

The mesh fabric may include a variety of materials including, for example, polyester mesh fabric, nylon mesh fabric, polyethylene mesh fabric, polypropylene mesh fabric, and/or other high-strength material mesh fabrics. The mesh fabric may also be formed from soft rubber threads or plastic threads. In some embodiments, materials, such as cotton and polyester, are also used to make mesh fabrics. Among them, polyester mesh fabric has high tensile strength and wear resistance, and nylon mesh fabric has wear resistance and good elasticity.

In some embodiments, the damping component 210 is provided on the inner surface of the rear housing 200, so that the outer surface of the rear housing 200 is clean and regular. The inner surface of the rear housing 200 is a surface of the rear housing 200 facing the first sound cavity 301, and the outer surface of the rear housing 200 is opposite to the inner surface along the front-rear direction of the display apparatus.

In some embodiments, the damping component 210 is provided on the outer surface of the rear housing 200, which facilitates diversified design of the damping component 210 and improves the aesthetics of the rear housing 200. Moreover, with the damping component 210 provided on the outside of the rear housing 200, it is not only easy to disassemble the damping component 210 for cleaning, maintenance, etc., but also does not occupy the internal space of the rear housing 200.

In some embodiments, the damping component 210 may be mounted in various ways. For example, the damping component 210 is adhered to the rear housing 200, which is a simple mounting method. As another example, the damping component 210 is snap-fitted to the rear housing 200, providing a simple and stable mounting method and facilitating disassembly. As yet another example, the damping component 210 is fixed to the rear housing 200 by screws, providing high stability.

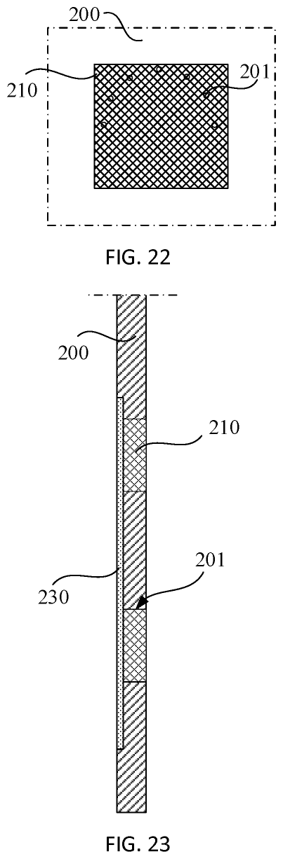

In some embodiments, the damping component 210 covers all of the sound outlet holes 201, and a shape of the damping component 210 may vary. For example, the damping component 210 is annular, covering only a region of the rear housing 200 where the sound outlet holes 201 are provided, as shown in FIG. 21, which can reduce the material consumption of the damping component 210. As another example, the damping component 210 is polygonal, e.g., rectangular, as shown in FIG. 22, covering the region of the rear housing 200 where the sound outlet holes 201 are provided and an inner region of the rear housing 200. Such an arrangement provides a simple structure for the damping component 210, facilitating processing, and provides a large contact area between the damping component 210 and the rear housing 200, which is beneficial to improving the installation stability and reliability of the damping component 210. Of course, the shape of the damping component 210 is not limited thereto, and may also be circular, elliptical, floral, etc.

In some embodiments, the damping component 210 is an integral structure, which facilitates overall installation of the damping component 210 and provides good appearance.

In some embodiments, the damping component 210 may be a split structure, i.e., the damping component 210 includes a plurality of mesh pieces, and the plurality of mesh pieces are spliced together to form the damping component 210. Such an arrangement allows the damping component 210 to be installed in parts, making the installation of the damping component 210 simpler and more flexible.

As shown in FIG. 23, the damping component 210 is provided within the sound outlet holes 201. The damping component 210 may be made of sponge, foam, sound-absorbing cotton, or the like, which can absorb sound waves and reduce the possibility of airflow noise at the sound outlet holes 201.

In some embodiments, the damping component 210 is configured so that the inside and outside of the rear housing 200 are in communication through the sound outlet holes 201. Thus, when sound waves pass through the sound outlet holes 201, part of the sound waves can be absorbed by the damping component 210, and part of the sound waves can still be transmitted to the outside of the rear housing 200 through the sound outlet holes 201, increasing the number of sound emission directions.

In some embodiments, the damping component 210 may be provided in the sound outlet holes 201 with an interference fit, providing a simple and reliable mounting method.

In some embodiments, the damping component 210 may also be fixed to the rear housing 200 by a fixing member. For example, the damping component 210 is fixed to a bracket, and the bracket may be mounted on the rear housing 200 by screwing, snap-fitting, adhesion, or the like.

In some embodiments, with reference to FIG. 23, an outer cover 230 is provided on a back side of the rear housing 200. The outer cover 230 covers a region where the sound outlet holes 201 are provided, protecting and shielding the damping component 210, and also helping to maintain the appearance of the rear housing 200.

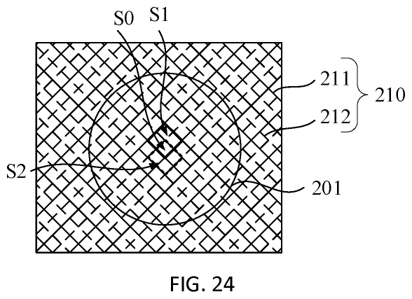

In some embodiments, referring to FIG. 24, the damping component 210 includes a plurality of layers of mesh. The plurality of layers of mesh are arranged in a stacked manner, and mesh wires of adjacent layers are arranged in a staggered manner, reducing an area of each individual mesh opening. Exemplarily, the damping component 210 includes a first mesh layer 211 and a second mesh layer 212 arranged in a stacked manner. The first mesh layer 211 has first mesh openings S1, and the second mesh layer 212 has second mesh openings S2. The mesh wires of the first mesh layer 211 and the mesh wires of the second mesh layer 212 are arranged in a staggered manner, so that the first mesh openings S1 and the second mesh openings S2 partially overlap, forming interwoven mesh openings S0 having a smaller individual opening area.

Compared with a single-layer mesh, the damping component 210 according to the embodiments of the present disclosure, by providing a plurality of layers of mesh, not only helps to reduce an opening area of each individual mesh opening, increase air flow resistance, and further reduce airflow noise, but also helps to improve a structural strength of the damping component 210, facilitating installation and fixation.

In some embodiments, the damping component 210 is a single-layer mesh. Mesh wires of the single-layer mesh partition the sound outlet holes 201 to form a plurality of small sound outlet holes, increasing air flow resistance and reducing airflow noise. Air flow is generated during sound wave radiation. The single-layer mesh damping component 210 can reduce resonance between a plurality of layers of mesh.

From the above description, when the rear housing 200 is provided with the sound outlet holes 201, the damping component 210 is provided on the rear housing 200, and the damping component 210 is configured so that the inside and outside of the rear housing 200 are in communication through the sound outlet holes 201. This not only ensures that sound waves are emitted through the sound outlet holes 201, reducing the vibration force of the sound waves on the rear housing 200, but also absorbs sound waves at the sound outlet holes 201, reducing the airflow noise at the sound outlet holes 201.

In some embodiments of the above description, the first speaker 300 may be provided with a third loudspeaker 340. The third loudspeaker 340 is configured to emit low-frequency sound, so that the first speaker 300 has bass characteristics. That is, a woofer is integrated into a speaker having midrange and treble frequencies.

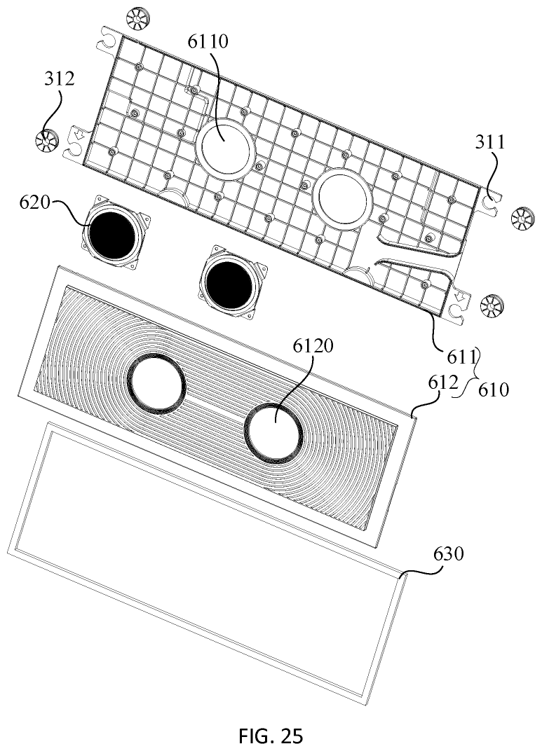

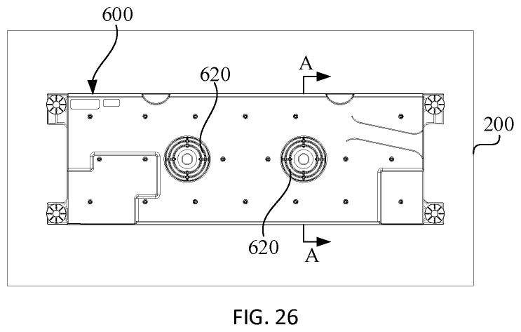

In some embodiments, the display apparatus may also be separately provided with a speaker configured to emit low-frequency sound. As shown in FIGS. 25 and 26, in some embodiments, the display apparatus 10 includes a second speaker 600. The second speaker 600 is configured to emit low-frequency sound. The second speaker 600 is mounted between the display module and the rear housing 200.

The second speaker 600 includes a fourth loudspeaker 620 for emitting low-frequency sound. The frequency of sound waves emitted by the fourth loudspeaker 620 may be lower than 200 Hz. The fourth loudspeaker 620 has low directivity requirements for sound waves, and no sound guide member needs to be provided outside the fourth loudspeaker 620.

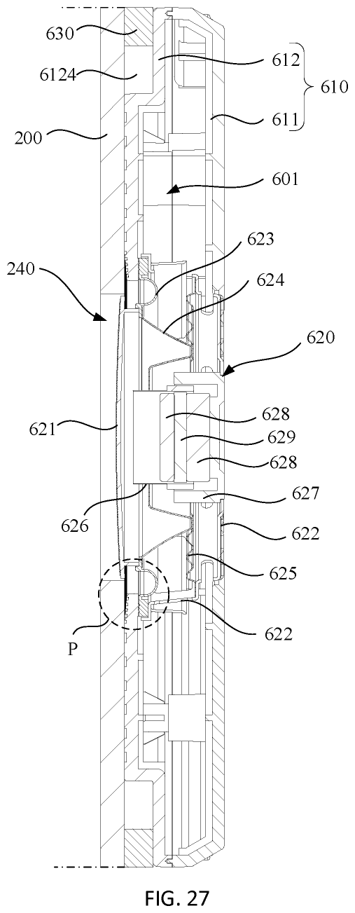

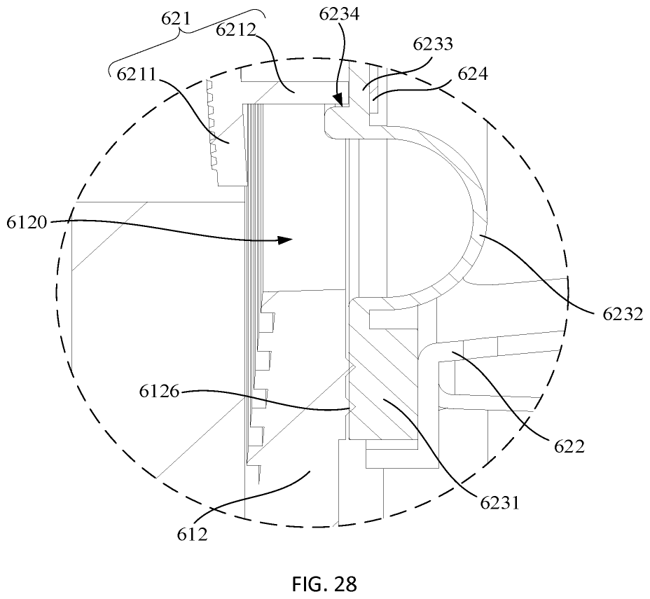

In some embodiments, with reference to FIGS. 27 and 28, the fourth loudspeaker 620 includes a bracket 622. The bracket 622 not only provides an installation position for a cone, a magnetic circuit structure, and the like, but also fixes the fourth loudspeaker 620 inside the speaker housing.

In some embodiments, the fourth loudspeaker 620 includes a magnetic circuit structure. The magnetic circuit structure includes a U-shaped magnetic yoke 627, a magnet 628, a washer 629, and a voice coil 626. The U-shaped magnetic yoke 627 is embedded in an opening provided at a center of a bottom of the bracket 622. The magnet 628 and the washer 629 are mounted inside the U-shaped magnetic yoke 627. The voice coil 626 is wound around outside of the magnet 628 and the washer 629, and a bottom of the voice coil 626 is located inside the U-shaped magnetic yoke 627. Gaps are provided between an inner surface of the voice coil 626 and both the magnet 628 and the washer 629, and a gap is provided between an outer surface of the voice coil 626 and the U-shaped magnetic yoke 627.

The fourth loudspeaker 620 further includes a first cone 623 and a second cone 624, both of which are annular. An outer side of the first cone 623 is attached to a top portion of the bracket 622, an inner side of the first cone 623 is attached to an outer side of the second cone 624, and an inner side of the second cone 624 is engaged with an outer side of a top portion of the voice coil 626. The first cone 623 and the second cone 624 are coaxially arranged, which helps to reduce phase differences and improve sound clarity and consistency. The fourth loudspeaker 620 further includes a damper 625. One end of the damper 625 is connected to the bracket 622, and the other end of the damper 625 is connected to the second cone 624.

In some embodiments, one or more fourth loudspeakers 620 may be provided. The number of the fourth loudspeakers 620 is related not only to the loudspeaker power but also to the net volume of the speaker. When the net volume of the second speaker 600 is relatively large, a plurality of fourth loudspeakers 620 may be arranged to increase the loudness of the speaker. When the net volume of the second speaker 600 is relatively small, one fourth loudspeaker 620 may be arranged to ensure low-frequency sound emission. Here, the net volume of the speaker is the volume of the speaker minus the space occupied by all components inside the speaker.

As shown in FIGS. 25 and 27, the second speaker 600 includes a second housing 610. The second housing 610 is configured to form a third sound cavity 601 for accommodating the fourth loudspeaker 620 and providing an installation position.

In some embodiments, the second housing 610 includes a first shell 611 and a second shell 612 connected to each other. The first shell 611 and the second shell 612 are fixedly connected to form the third sound cavity 601. The fourth loudspeaker 620 may be fixedly connected to the first shell 611 and/or fixedly connected to the second shell 612, so that the fourth loudspeaker 620 is fixed within the third sound cavity 601.

In some embodiments, with reference to FIG. 25, the first shell 611 serves as a front side housing of the second housing 610 and is close to a back plate of the display apparatus. The first shell 611 may be mounted elastically on the back plate, and the mounting method may refer to that of the speaker housing 310, which will not be repeated here. The second shell 612 serves as a rear side housing of the second housing 610 and is close to the rear housing 200 of the display apparatus.

A vibration damping member 630 is provided between the second shell 612 and the rear housing 200 for damping vibration transmitted from the second speaker 600 to the rear housing 200. The vibration damping member 630 may be adhered to the second shell 612 or the rear housing 200, providing a simple and reliable connection method. Alternatively, the vibration damping member 630 is sandwiched between the second shell 612 and the rear housing 200, without requiring any additional connection structure for the vibration damping member 630. Exemplarily, the vibration damping member 630 may be made of sponge, foam, or the like.

The vibration damping member 630 is annular and surrounds outside of the fourth loudspeaker 620. In certain embodiments, the vibration damping member 630 is provided at an edge of the second shell 612, so that a region inside the vibration damping member 630 may be exposed to the outside of the rear housing 200.

In some embodiments of the present disclosure, the fourth loudspeaker 620 is mounted on the second shell 612. Such an arrangement facilitates positional adjustment for centering a cone of the fourth loudspeaker 620 with a through hole in the second shell 612, improves the convenience of fitting and connecting the cone with the second shell 612, and also improves the accuracy of the relative position between an outer cover of the fourth loudspeaker 620 and the second shell 612, making adjustment of a mounting position of the fourth loudspeaker 620 more flexible.

In the existing technology, the second housing 610 is mostly made of plastic material. When the second housing 610 has insufficient strength, the second housing 610 is prone to deformation, losing sound wave energy, and is also prone to resonate with sound waves, generating noise.

A structural strength of the second housing 610 can be improved by increasing a wall thickness, but this is not favorable for thinning design of the speaker.

The structural strength of the second housing 610 can also be improved by adding ribs, connecting posts, or the like, but this makes a molding die structure of the second housing 610 complex.

In some embodiments, at least a portion of the second housing 610 is a metal plate portion. Such an arrangement helps to improve the structural strength of the second housing 610 and reduce deformation of the second housing 610. Exemplarily, at least a portion of the first shell 611 is a metal plate portion. Exemplarily, at least a portion of the second shell 612 is a metal plate portion.

In some embodiments, the first shell 611 includes a metal plate portion and an injection-molded plate portion; and/or the second shell 612 includes a metal plate portion and an injection-molded plate portion. The metal plate portion may be adhered to the injection-molded plate portion, providing a simple connection method. Alternatively, the metal plate portion may be used as an insert during injection molding of the injection-molded plate portion, integrally formed with the injection-molded plate portion, providing a stable and reliable connection. The injection-molded plate portion may be a plastic plate portion.

In some embodiments, the second housing 610 is a metal housing, which helps to improve structural strength and reduce the wall thickness of the housing, facilitating the thinning design of the speaker.

In some embodiments, the fourth loudspeaker 620 is mounted on a region of the second housing 610 other than the metal plate portion, for example, on the injection-molded plate portion. Such an arrangement facilitates forming connecting posts in other regions of the metal plate portion, with a simple method of forming the connecting posts, and makes the mounting method of the fourth loudspeaker 620 simple and reliable.

In some embodiments, a magnetic circuit structure of the fourth loudspeaker 620 contacts the metal plate portion. For example, the U-shaped magnetic yoke 627 of the fourth loudspeaker 620 contacts the metal plate portion, to increase a heat dissipation area of the fourth loudspeaker 620, improving a heat dissipation effect of the fourth loudspeaker 620.

With reference to FIG. 25, in some embodiments, the first shell 611 is provided with an opening 6110 in communication with the third sound cavity 601, so that at least part of the fourth loudspeaker 620 is exposed to outside of the second housing 610. Exemplarily, the bracket 622 of the fourth loudspeaker 620 is exposed to the outside of the second housing 610 through the opening 6110, which is beneficial to improving the heat dissipation effect of the fourth loudspeaker 620.

In some embodiments, at least part of the bracket 622 is located within the opening 6110, so that the at least part of the bracket 622 is embedded in the opening 6110, which can reduce an independent space that needs to be reserved for the bracket 622, helping to reduce the overall thickness of the second speaker 600.

In some embodiments, the second shell 612 is provided with a second sound outlet through hole 6120 in communication with the third sound cavity 601, so that at least part of the fourth loudspeaker 620 is exposed to the outside of the second housing 610. Exemplarily, the first cone 623 and the second cone 624 of the fourth loudspeaker 620 are exposed to the outside of the second housing 610 through the second sound outlet through hole 6120, facilitating outward propagation of sound waves.

In some embodiments, the first cone 623 and the second cone 624 are each arranged coaxially with the second sound outlet through hole 6120, which facilitates outward propagation of sound waves and prevents the second shell 612 from blocking vibrating portions of the cones and affecting sound wave transmission.

In some embodiments, the second sound outlet through hole 6120 is arranged coaxially with the opening 6110. Such an arrangement simplifies the mounting of the fourth loudspeaker 620.

An amplitude and airflow of the fourth loudspeaker 620 are generally relatively large. Therefore, a gap is provided between the second speaker 600 and the rear housing 200 of the display apparatus to reduce a vibration force acting on the rear housing 200 and reduce vibration of the rear housing 200.

However, the gap between the second speaker 600 and the rear housing 200 increases an installation space occupied by the second speaker 600, which is detrimental to thinning design of the display apparatus and the second speaker 600.

With reference to FIGS. 26 to 27, in some embodiments, the rear housing 200 is provided with a first sound outlet through hole 240, so that at least part of the second speaker 600 is exposed to the outside of the rear housing 200 through the first sound outlet through hole 240. The second sound outlet through hole 6120 of the second speaker 600 is at least partially opposite the first sound outlet through hole 240, so that sound waves can be transmitted outward through the first sound outlet through hole 240.

As shown in FIG. 27, the fourth loudspeaker 620 further includes an outer cover 621. The outer cover 621 serves as an appearance or decorative component of the fourth loudspeaker 620 and is exposed to the outside of the rear housing 200.

The outer cover 621 is connected to the cone of the woofer. The outer cover 621 faces at least part of the cone of the fourth loudspeaker 620. Thus, the outer cover 621 can protect the cone, and the outer cover 621 vibrates under the drive of the cone, radiating sound waves.

In some embodiments of the present disclosure, the fourth loudspeaker 620 has a first cone 623 and a second cone 624. The outer cover 621 is connected to the first cone 623, and is also connected to a joint between the first cone 623 and the second cone 624. The joint between the first cone 623 and the second cone 624 has relatively high hardness, which is beneficial to improving the stability of the connection of the outer cover 621.

In some embodiments, a side of the outer cover 621 facing away from the cone is a convex curved surface structure, for example, a convex arc surface, which has a relatively large surface area and is beneficial to radiating sound waves.

In some embodiments, the outer cover 621 is adhered to a cone of the fourth loudspeaker 620. For example, in some embodiments of the present disclosure, the outer cover 621 is adhered to the first cone 623, providing a simple connection method.

As shown in FIG. 28, the first cone 623 includes a surround 6231, an outer connecting edge 6232, and an inner connecting edge 6233. The surround 6231 is U-shaped, with its inner side connected to the inner connecting edge 6233 and its outer side connected to the outer connecting edge 6232. The outer connecting edge 6232 is attached to the bracket 622, and the inner connecting edge 6233 is connected to the second cone 624. The surround 6231 vibrates under the drive of the second cone 624.

The outer cover 621 is adhered to the inner connecting edge 6233. Since the inner connecting edge 6233 is connected to the second cone 624 and has relatively high hardness, this helps to ensure the stability of the connection between the outer cover 621 and the first cone 623.

If the outer cover 621 is adhered to the surround 6231, the connection stability of the outer cover 621 may be poor because the surround 6231 is relatively soft.

If the outer cover 621 is connected to the outer connecting edge 6232, since the outer connecting edge 6232 is attached to the bracket 622 and does not move, the outer cover 621 may not move, which may block sound waves and affect the sound effect of the woofer 620.

With continued reference to FIG. 28, the outer cover 621 includes a cover plate 6211 and a connecting portion 6212. The connecting portion 6212 is disposed on a side of the cover plate 6211 facing the cone of the fourth loudspeaker 620. The connecting portion 6212 is connected to the first cone 623. The connecting portion 6212 is annular, so that the outer cover 621 matches a limited connection area of the first cone 623.

As shown in FIG. 28, a side of the second shell 612 facing the first cone 623 is provided with a rib 6126. The rib 6126 abuts against the outer connecting edge 6232 of the first cone 623. When the fourth loudspeaker 620 is fixed to the second shell 612, the outer connecting edge 6232 is pressed against the rib 6126. Provision of the rib 6126 facilitates positioning of the fit between the first cone 623 and the second shell 612, increases the friction between the outer connecting edge 6232 and the second shell 612, and reduces the possibility of movement between the first cone 623 and the second shell 612.

In some embodiments, the rear housing 200 is provided with a first sound outlet through hole 240 to expose the outer cover 621 to the outside of the rear housing 200. With reference to FIG. 27, the outer cover 621 is located within the first sound outlet through hole 240, leaving space for vibration of the outer cover 621. Moreover, the outer cover 621 does not need to separately occupy space in a thickness direction of the display apparatus, which is beneficial to reducing the overall thickness of the second speaker 600.

Because an adhesion area between the outer cover 621 and the first cone 623 is small, the connection between the outer cover 621 and the cone is unstable, and the glue may easily fail, causing the outer cover 621 to detach. In view of this, in some embodiments, with reference to FIGS. 27 and 28, the outer cover 621 is snap-fitted to the cone of the fourth loudspeaker 620, making the connection between the outer cover 621 and the cone more stable and reliable.

In some embodiments of the present disclosure, the connecting portion 6212 of the outer cover 621 is snap-fitted to the inner connecting edge 6233 of the first cone 623. The inner connecting edge 6233 of the first cone 623 has relatively high hardness, which is beneficial to improving the stability of the snap-fit connection between the connecting portion 6212 and the inner connecting edge 6233.

With reference to FIG. 28, in some embodiments, the inner connecting edge 6233 of the first cone 623 is provided with a recess 6234, and the connecting portion 6212 of the outer cover 621 is snap-fitted into the recess 6234, providing a simple structure and a reliable connection method.

The recess 6234 is formed on an inner side of the inner connecting edge 6233, providing a simple processing method. Because the first cone 623 is elastic, the snap-fit connection between the connecting portion 6212 and the recess 6234 is achieved by elastic deformation of a side wall of the recess 6234.

In some embodiments, the connecting portion 6212 is snap-fitted into the recess 6234, and the connecting portion 6212 is also adhered to a bottom wall of the recess 6234, further improving the stability and reliability of the connection between the outer cover 621 and the first cone 623.

Speakers at different positions of the display apparatus may produce different sound effects. Arrangement of speakers relative to the rear housing of the display apparatus in some embodiments of the present disclosure is described below with reference to the accompanying drawings.

For ease of description, the rear housing 200 is defined as having a vertical centerline O2 and a horizontal centerline O1. The vertical centerline O2 extends in a vertical direction, and the rear housing 200 has a top side and a bottom side opposite to each other in the vertical direction. The horizontal centerline O1 extends in a horizontal direction, and the rear housing 200 has a left side and a right side opposite to each other in the horizontal direction.

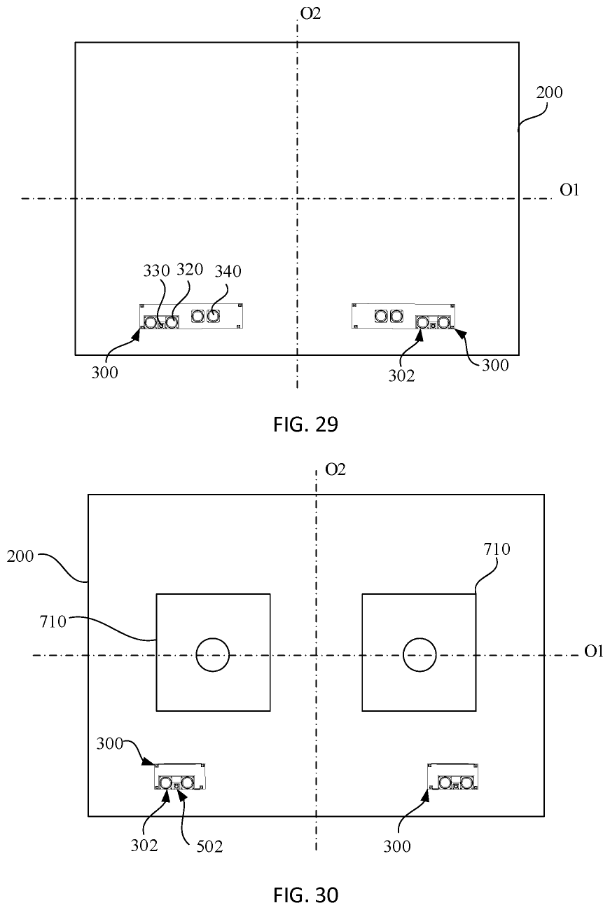

In some embodiments, as shown in FIG. 29, two first speakers 300 as shown in FIGS. 3 and 4 are provided, both located on the bottom side of the rear housing 200, below the horizontal centerline O1 and close to a bottom edge of the rear housing 200. First sound outlets 302 of the two first speakers 300 face downward, so that the two first speakers 300 emit sound downward. The two first speakers 300 are arranged symmetrically with respect to the vertical centerline O2. Moreover, the third loudspeaker 340 that emits low-frequency sound is located close to the vertical centerline O2. Such an arrangement provides a relatively large spacing between the first loudspeakers 320 and the second loudspeakers 330 of the two first speakers 300, which is beneficial to improving a sound field width and stereo effect of the display apparatus.

In some embodiments, as shown in FIG. 30, the display apparatus includes a subwoofer speaker 710 to improve low-frequency sound of the display apparatus. The subwoofer speaker 710 may be a subwoofer speaker having a sound guide baffle according to the existing technology, or the subwoofer speaker 710 may be the second speaker 600 as shown in FIG. 25.

Generally, the second speaker 600 occupies a relatively large installation area. The second speaker 600 may be mounted at a central position of the rear housing 200. For example, two second speakers 600 are arranged at intervals in a horizontal direction, and the two second speakers 600 are arranged symmetrically with respect to both the vertical centerline O2 and the horizontal centerline O1.

With continued reference to FIG. 30, the display apparatus further includes two first speakers 300. The first speakers 300 may have the structure shown in FIG. 13, FIG. 14, or FIG. 16, and have no woofer inside. The two first speakers 300 are located below the horizontal centerline O1 and close to the bottom edge of the rear housing 200. The first sound outlets 302 of the two first speakers 300 face downward, so that the two first speakers 300 emit sound downward. The two first speakers 300 are arranged symmetrically with respect to the vertical centerline O2. The two first speakers 300 may form left and right channels and/or center channels of the display apparatus.

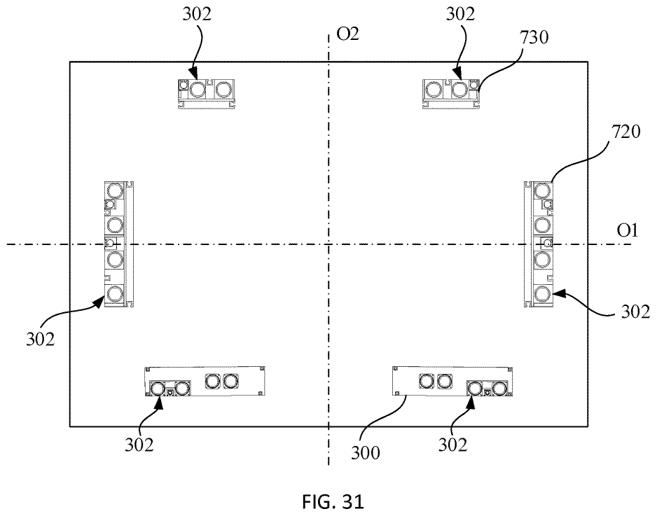

In some embodiments, as shown in FIG. 31, based on the structure shown in FIG. 29 or FIG. 30, the display apparatus further includes surround channel speakers 720, which is beneficial to improving the surround sound and stereo effect of the display apparatus. The surround channel speakers 720 are respectively arranged on left and right sides of the rear housing 200 to form surround channels of the display apparatus. The two surround channel speakers 720 are symmetric with respect to the vertical centerline O2 and also symmetric with respect to the horizontal centerline O1, ensuring symmetry of sound wave transmission.

The surround channel speakers 720 emit sound laterally. A sound outlet of a left surround channel speaker 720 faces left, so that the left surround channel speaker 720 emits sound leftward; a sound outlet of a right surround channel speaker 720 faces right, so that the right surround channel speaker 720 emits sound rightward.

The surround channel speakers 720 may be any suitable surround channel speakers. In one embodiment, the surround channel speakers 720 may adopt the first speaker 300. For example, the two first speakers 300 forming the surround channels may have different numbers of loudspeakers, different power, etc., compared with the first speakers 300 arranged at the bottom.

In some embodiments, as shown in FIG. 31, the display apparatus further includes two top speakers 730. The top speakers 730 (e.g., a height speaker) may be any suitable top speakers. In one embodiment, the top speakers 730 may adopt the first speaker 300. The first speaker 300 may not have a woofer, and the first sound outlet of the first speaker 300 faces upward, so that the top speaker emits sound upward. The two first speakers 300 are arranged above the horizontal centerline O2 and close to a top edge of the rear housing 200. The two first speakers 300 are arranged symmetrically with respect to the vertical centerline O2. Such an arrangement improves the stereo effect of the display apparatus.

It should be noted that when the first speaker 300 is mounted at different positions of the rear housing 200, power, frequencies, etc., of the first loudspeaker 320 and the second loudspeaker 330 of the first speaker 300 may be different.

It should be noted that any technical scheme disclosed in the present disclosure may solve one or more of the above technical problems and achieve certain inventive objectives to some extent. A plurality of technical disclosures may also be combined into an overall scheme to solve one or more of the above technical problems and achieve certain inventive objectives. Alternatively, some technical disclosures may be selected and combined into an overall scheme, adopting existing technology and inferior schemes, but the inferior trend may be compensated by the disclosed technical means, to solve one or more of the above technical problems and achieve certain inventive objectives as a whole. Each technical disclosure combined into a complete technical scheme constitutes an organic and inseparable overall scheme, solving the technical problems and achieving certain inventive objectives as a whole.

It should be understood by those skilled in the art that the scope of the present disclosure is not limited to embodiments described above, and modifications and substitutions may be made to certain elements of the embodiments without departing from the spirit of the present disclosure. The scope of the present disclosure is defined by the appended claims.

What is claimed is:

1. A display apparatus, comprising:
a display module, having a display side and a back side opposite to the display side along a thickness direction of the display apparatus, wherein the display side of the display module faces a front side of the display apparatus, and the display module comprises:
a display panel, configured to display image information;
a backlight assembly, configured to provide backlight for the display panel; and
a back plate, configured to provide an installation position for the backlight assembly;
a rear housing, being an exterior component of the display apparatus and located on the back side of the display module, wherein the back plate is located between the backlight assembly and the rear housing;
a side frame, connected between an edge of the rear housing and an edge of the display module, the side frame being provided with sound holes;
a first speaker, mounted on the back plate and located between the display module and the rear housing, the first speaker comprising:
a speaker housing;
a first loudspeaker, wherein a sound output direction of the first speaker faces the rear housing, and a diaphragm of the first loudspeaker is spaced apart from the rear housing, and wherein the speaker housing provides an installation position for the first loudspeaker;
a first sound guide member, located between the speaker housing and the rear housing, and in contact with the speaker housing and the rear housing respectively, wherein the first sound guide member, the speaker housing, and the rear housing together enclose a first sound cavity, and the first loudspeaker is located within the first sound cavity; wherein the first sound guide member forms at least part of a first sound outlet, the first sound outlet is in communication with the first sound cavity, and the first sound cavity, the first sound outlet, and the sound holes form a sound output channel; the first sound guide member is elastic to elastically connect the speaker housing and the rear housing;
wherein the first sound guide member is configured to guide sound waves facing the rear housing to a lateral side, at least a part of sound waves from the first speaker are emitted through the first sound outlet under confinement of the first sound guide member and the rear housing, to provide lateral sound emission of the first speaker; wherein the first speaker has a front side and a rear side along the thickness direction of the display apparatus, and the first sound outlet is provided on a side of the first speaker other than the front side and the rear side of the first speaker.

2. The display apparatus according to claim 1, wherein:
the first sound guide member comprises an elastic portion, and the elastic portion is in contact with the speaker housing or the rear housing; or,
the first sound guide member is an elastic member.

3. The display apparatus according to claim 1, wherein:
the first sound guide member is connected to the speaker housing, and/or
the first sound guide member is connected to the rear housing.

4. The display apparatus according to claim 3, wherein:
the first sound guide member is adhered to the speaker housing, and/or the first sound guide member is adhered to the rear housing; or,
the first sound guide member is sandwiched between the speaker housing and the rear housing, and the speaker housing and/or the rear housing is provided with a limiting portion cooperating with the first sound guide member.

5. The display apparatus according to claim 1, wherein:
the first sound guide member is formed with a break to semi-surround an outside of the first loudspeaker, and the break forms the at least part of the first sound outlet.

6. The display apparatus according to claim 1, wherein:
the first sound guide member is in a closed ring shape, a side of the first sound guide member facing the speaker housing is recessed toward the rear housing to form a notch, and the notch forms the at least part of the first sound outlet.

7. The display apparatus according to claim 1, wherein the speaker housing is formed with a mounting groove for accommodating the first loudspeaker, a groove side wall of the mounting groove is provided with an opening, and the opening together with the first sound guide member forms the first sound outlet.

8. The display apparatus according to claim 1, wherein the first sound guide member comprises a plurality of sound guide strips, and the plurality of sound guide strips are spliced together to form the first sound guide member.

9. The display apparatus according to claim 1, wherein the display apparatus further comprises a second loudspeaker, and the second loudspeaker is mounted on the speaker housing and located within the first sound cavity; at least part of a sound wave frequency of the second loudspeaker is different from a sound wave frequency of the first loudspeaker; and
the display apparatus further comprises a second sound guide member, and the second sound guide member is located within the first sound cavity and is in contact with both the rear housing and the speaker housing; the second sound guide member, the rear housing, and the speaker housing together enclose a second sound cavity, and the second sound guide member forms a second sound outlet at a side of the first sound outlet; the second loudspeaker is located within the second sound cavity.

10. The display apparatus according to claim 1, wherein a third loudspeaker is mounted on a side of the speaker housing facing the rear housing, and a diaphragm of the third loudspeaker is spaced apart from the rear housing.

11. The display apparatus according to claim 1, wherein an inner side surface of the first sound guide member facing the first sound cavity is planar.

12. The display apparatus according to claim 1, wherein a thickness of the first sound guide member is not less than 2 mm and not greater than 4 mm.

13. The display apparatus according to claim 1, wherein a width of the first sound guide member is not less than 8 mm and not greater than 10 mm.

14. The display apparatus according to claim 9, wherein the second loudspeaker is a tweeter, and the first loudspeaker is a full-range loudspeaker.

15. The display apparatus according to claim 1, wherein the first loudspeaker is located on a bottom side of the rear housing, and the first sound outlet faces downward, so that the first loudspeaker emits sound downward.

16. The display apparatus according to claim 1, wherein the speaker housing is plate-shaped, and a partial region of the rear housing opposite the speaker housing is also plate-shaped.
